(19) United States
(12) Patent Application Publication
(10) Pub. No.: US 2023/0349373 A1
(43) Pub. Date: Nov. 2, 2023

(54) Microfluidic Devices and Methods Including Flexible Membranes

(71) Applicant: Redbud Labs, Inc.

(72) Inventors: Adam Kwok Hing Dengler, Research Triangle Park, NC (US); Richard Chasen Spero, Research Triangle Park, NC (US)

(73) Assignee: Redbud Labs, Inc., Research Triangle Park, NC (US)

(21) Appl. No.: 18/014,923

(22) PCT Filed: Jul. 7, 2021
(86) PCT No.: PCT/US21/40642

§ 371 Date: Jan. 6, 2023

Related U.S. Application Data
(60) Provisional application No. 63/048,872, filed on Jul. 7, 2020.

(51) Int. Cl. F04B 43/04

(52) U.S. Cl. CPC F04B 43/043

(57) ABSTRACT

A magnetically actuated pump for pumping liquids in microfluidic devices including one or more substrates and a first flexible membrane arranged to form a pumping chamber having an initial size and volume one or more ports into the pumping chamber.

### RELATED APPLICATIONS

The presently disclosed subject matter is related to and claims priority to U.S. Provisional Patent Application No. 63/048,872, entitled “MICROFLUIDIC DEVICES AND METHODS INCLUDING FLEXIBLE MEMBRANES AND/OR MAGNETICALLY RESPONSIVE ELEMENTS,” filed on Jul. 7, 2020; the entire disclosure of which is incorporated herein by reference.

### FIELD OF THE INVENTION

The invention relates to microfluidic devices and methods including flexible membranes and/or magnetically-responsive elements.

### BACKGROUND

Microfluidic systems may include active surfaces for processing biological materials. Active surfaces may, for example, be used to facilitate mixing operations, washing operations, binding operations, and cell processing operations. The operations may take place in a reaction (or assay) chamber. However, there is often little or poor control of the fluid flowing within the chamber. New approaches are needed to provide better fluid flow control in a microfluidic system.

### SUMMARY OF THE INVENTION

The invention provides a magnetically actuated pump. The pump may include one or more substrates and a first flexible membrane arranged to form a pumping chamber having an initial size and volume. The pump may include one or more ports into the pumping chamber. The pump may be included as part of a microfluidic device.

In some cases the one or more substrates includes a base substrate having a top surface and a bottom surface; one or more spacers, each having one or more inner surfaces and an outer surfaces; the first flexible membrane has a top surface and a bottom surface, and the one or more spacers separate the top surface of the substrate and the bottom surface of the flexible membrane thereby forming a flow chamber bounded by: the top surface of the base substrate, the bottom surface of the flexible membrane, and the one or more inner surfaces of the one or more spacers, and the one or more ports include: one or more ports in the substrate; one or more ports in any of the one or more spacers; and/or one or more ports in the membrane.

In some embodiments, the one or more substrates include a rigid substrate. In some embodiments, the one or more substrates include a flexible substrate. In some embodiments, the one or more substrates include a second flexible membrane. In some embodiments, the bottom surface of the flexible membrane includes actuatable microposts extending into the flow chamber. In some embodiments, the top surface of the substrate includes actuatable microposts extending into the flow chamber.

In some embodiments, the flexible membrane is configured so that flexing the flexible membrane towards the substrate causes the flow chamber to have a decreased size and volume compared to the initial size and volume. In some embodiments, the flexible membrane is configured so that flexing the flexible membrane away from the substrate causes the flow chamber to have an increased size and volume compared to its initial size and volume.

In some embodiments, the one or more substrates include a substrate formed of a flexible and magnetically responsive material. In some embodiments, the flexible membrane is formed of a flexible and magnetically responsive material. In some embodiments, the flexible membrane has a thickness ranging from about 500 μM to about 3,000 μM. In some embodiments, the flexible membrane has a thickness ranging from about 200 μM to about 1,500 μM.

The flexible and magnetically responsive material may, for example, include silicone, hydrogel, polydimethylsiloxane (PDMS), a thermoplastic elastomer, and/or a fluoropolymer. The flexible and magnetically responsive material may, for example, include iron, nickel, cobalt, ferroferric oxide, barium hexaferrite, cobalt(II) oxide, nickel(II) oxide, manganese(III) oxide, chromium(III) oxide, and/or cobalt manganese phosphide.

In some embodiments, the ports include one or more ports in the substrate. In some embodiments, the ports include one or more ports in the one or more spacers. In some embodiments, the ports include one or more ports in the flexible membrane. In some embodiments, the one or more ports are valved. In some embodiments, the one or more ports are coupled to microfluidic passages of a microfluidic device. In some embodiments, the one or more ports are coupled to valved microfluidic passages of a microfluidic device.

In some embodiments, substrate includes a bowl-shaped region. In some embodiments, substrate includes a dome shaped region.

The invention provides a microfluidics system. The system may include the magnetically actuated pump of the invention. The system may include a magnet actuator arranged to actuate the flexible membrane and thereby cause fluid to flow into and/or out of the chamber. The system may include a magnet actuator arranged to magnetically effect peristaltic actuation of the flexible membrane and thereby cause fluid to flow into and/or out of the chamber.

The system may include two magnetically actuated pump of the invention arranged for reciprocal pumping of liquid in the chamber; and one or more a magnet actuators arranged to magnetically effect reciprocal actuation of the flexible membrane and thereby cause fluid to flow into and/or out of the chamber.

The invention provides a method of pumping liquid. The method may include providing a pump of the invention and causing the magnet actuator arranged to actuate the flexible membrane and thereby cause fluid to flow into and/or out of the chamber. The method may include causing the magnet actuator arranged to actuate the flexible membrane and thereby cause fluid to flow into the chamber via a first port and out of the chamber via a second port. The method may include causing the magnet actuator arranged to actuate the flexible membrane and thereby cause fluid to flow into the chamber via a first valve-controlled port and out of the chamber via a valve controlled second port. The method may include pumping the liquid pursuant to any of pumping methods of the invention and actuating the actuatable microposts to cause mixing of fluid in the chamber.

The method may include repeatedly flexing the flexible membrane to cause fluid to flow into and out of the chamber via the one or more ports. Examples of flexing means include solenoid and piston mechanism and a pneumatic mechanism.

In some embodiments, the flexible membrane includes actuatable microposts extending into the flow chamber, and the method includes applying an actuating force to actuate the microposts to thereby mix fluid in the chamber. The fluid may, for example, be a reagent or a sample or a combination of reagent and sample. Any liquids ordinarily pumped in a microfluidic device may be pumped pursuant to the methods of the invention. Any liquids ordinarily pumped and mixed in a microfluidic device may be pumped and mixed pursuant to the methods of the invention.

The invention provides a magnetically actuated flow metering device comprising one or more substrates and a first flexible membrane arranged to form an open or closed fluid flow path. The one or more substrates may include a rigid substrate. In some embodiments, the one or more substrates include a flexible substrate. In some embodiments, the one or more substrates include a second flexible membrane. In some embodiments, the flexible membrane is configured so that flexing the flexible membrane towards the flow path reduces flow through the flow path. In some embodiments, the flexible membrane is configured so that flexing the flexible membrane away from the flow path reduces flow through the flow path. In some embodiments, the flexible membrane is configured so that flexing the flexible membrane towards the flow path closes the flow path. In some embodiments, the flexible membrane is configured so that flexing the flexible membrane away from the flow path closes the flow path. In some embodiments, the flexible membrane is biased to closed. In some embodiments, the flexible membrane is biased to open. In some embodiments, the flexible membrane has a thickness ranging from about 500 μM to about 3,000 μM. In some embodiments, the flexible membrane has a thickness ranging from about 200 μM to about 1,500 μM. In some embodiments, the flexible membrane is formed of a flexible and magnetically responsive material. In some embodiments, the flexible and magnetically responsive material includes silicone, hydrogel, polydimethylsiloxane (PDMS), a thermoplastic elastomer, and/or a fluoropolymer. In some embodiments, the flexible and magnetically responsive material includes iron, nickel, cobalt, ferroferric oxide, barium hexaferrite, cobalt(II) oxide, nickel(II) oxide, manganese(III) oxide, chromium(III) oxide, and/or cobalt manganese phosphide. In some embodiments, the one or more ports are coupled to microfluidic passages of a microfluidic device. In some embodiments, the one or more ports are coupled to valved microfluidic passages of a microfluidic device. In some embodiments, the substrate includes a bowl-shaped region. In some embodiments, the substrate includes a dome shaped region.

The invention provides a microfluidics device. In one embodiment, the microfluidics device may include: a substrate having a top surface and a bottom surface and a flexible membrane having a top surface and a bottom surface, wherein the substrate and the flexible membrane may be separated by spacers having an inner surface and an outer surface, wherein the spacers may separate the top surface of the substrate and the bottom surface of the flexible membrane thereby forming a flow chamber bounded by the top surface of the substrate, the bottom surface of the flexible membrane, and the inner surface of the spacers, and wherein the flow chamber may have an initial size and volume; and fluid inlet ports and fluid outlet ports in the substrate may fluidly connect to the flow chamber.

In certain embodiments, the substrate may be a rigid substrate, while in other embodiments, the substrate may be a flexible substrate. In certain embodiments, flexing the flexible membrane towards the substrate may cause the flow chamber to have a decreased size and volume compared to its initial size and volume.

In yet another embodiment, flexing the flexible membrane away from the substrate may cause the flow chamber to have an increased size and volume compared to its initial size and volume.

In still another embodiment, the microfluidics device may include a flexing means for flexing the membrane, wherein actuation of the flexing means may cause the flow chamber to decrease in size and volume compared to its initial size and volume or to increase in size and volume compared to its initial size and volume.

In certain embodiments, the bottom surface of the flexible membrane may include actuatable microposts extending into the flow chamber. In yet another embodiment, the top surface of the substrate may include actuatable microposts extending into the flow chamber. In certain embodiments, the substrate may be a flexible membrane having a top surface and a bottom surface, and wherein fluid inlet ports and fluid outlet ports may pass through the spacers to fluidly connect to the flow chamber. In certain embodiments, the top surface of the substrate may be a flexible membrane that includes actuatable microposts extending into the flow chamber. In certain embodiments, the microfluidics device may include a fluid input valve fluidly connected to one or more of the fluid inlet ports and a fluid output valve fluidly connected to one or more of the fluid outlet ports. In still another embodiment, the microfluidics device may include a valve control means for opening and closing the valves. In yet another embodiment, the substrate and/or the flexible membrane may be magnetically-responsive, and wherein applying a magnetic force to the flexible membrane may cause flexing of the flexible membrane. In certain embodiments, the substrate and/or the flexible membrane may include a flexible material doped with a magnetically-responsive material, wherein application of a magnetic force to the magnetically-responsive material may cause flexing of the flexible material. In certain embodiments, magnetic force may be applied to a top surface and/or a bottom surface of a magnetically-responsive flexible membrane that may cause flexing towards and/or away from the substrate. In certain embodiments, the flexible material may be selected from a group consisting of silicone, hydrogel, polydimethylsiloxane (PDMS), a thermoplastic elastomer, and a fluoropolymer. In certain embodiments, the flexible membrane may have a thickness of between about 200 μM to about 1,500 μM. In yet another embodiment, the magnetically-responsive material may be selected from a group consisting of iron (Fe), nickel (Ni), cobalt (Co), ferroferric oxide (Fe₃O₄), barium hexaferrite (BaFe₁₂O₁₉), cobalt(II) oxide (CoO), nickel(II) oxide (NiO), manganese(III) oxide (Mn₂O₃), chromium(III) oxide (Cr₂O₃), and cobalt manganese phosphide (CoMnP). In certain embodiments, fluid inlet and outlet ports may be fluidly coupled to the flexible membrane to allow fluid to flow into and out of the flow chamber. In yet another embodiment, the substrate may have a bowl-like topological shape or, in a different embodiment, a dome-like topological shape.

The invention provides a method for controlling fluid flow in a chamber of a microfluidics device. In one embodiment, the method may include sequentially performing the steps of: (a) providing a microfluidics device according to the invention, wherein the magnetically-responsive flexible membrane may possess a flat topological shape, and wherein the fluid input and output ports of the microfluidics device may be open; (b) closing the fluid output port to prevent fluid from flowing out of the flow chamber; (c) opening the fluid input port to thereby allow fluid to flow into the flow chamber; (d) closing the fluid input port when a first desired fluid volume may be present in the flow chamber; (e) actuating an external flexation means to cause flexing of the flexible membrane towards the rigid substrate, wherein the flexible membrane may form a bowl-like topological shape, thereby displacing a second desired amount of fluid which may flow out of the flow chamber upon concurrent opening of the fluid output port; (f) closing the fluid output port once the second desired volume of fluid has been removed from the flow chamber; (g) performing desired microfluidics operations on the fluid in the flow chamber to completion; and (h) actuating the flexation means to cause unflexing (de-flexing) of the flexible membrane, wherein the flexible membrane may return to the flat (or neutral) topological shape, and concurrently opening the fluid input port, thereby causing fluid to flow into the flow chamber.

In certain embodiments, steps (b) through (h) of the method may be sequentially repeated to cause a fluid pumping action, thereby producing a continuous flow of fluid into and out of the flow chamber. In certain embodiments, the external flexation means may be selected from a group consisting of a solenoid and piston mechanism and a pneumatic mechanism. In yet another embodiment, the method may further include the step of applying a magnetic force to actuate magnetically-response surface-attached microposts extending into the flow chamber to cause the microposts to move, thereby mixing the fluid in the flow chamber. In certain embodiments, the fluid may be a sample, a reagent, or a combination of both.

The invention also provides a magnetic-based pinch valve for use in a microfluidics device. In one embodiment, the magnetic-based pinch valve may include a bottom substrate having a top surface and a bottom surface with an opening therethrough that may be sized to substantially align with a pinch valve chamber of a pinch valve layer. In certain embodiments, the magnetic-based pinch valve may include a magnetically-responsive flexible membrane with a top surface and a bottom surface, and wherein the top surface of the membrane may be mounted on the top surface of the bottom substrate. In yet another embodiment, the magnetic-based pinch valve may include a pinch valve layer with a top surface and a bottom surface that may include a pinch valve chamber that may be sized to substantially align with the opening in the bottom substrate and mounted on the top surface of the membrane, wherein a portion of the membrane may be held suspended in a free space possesses a span (s) bounded by the pinch valve chamber in the pinch valve layer and the opening in the bottom substrate, and wherein the bottom surface of the pinch valve layer may be mounted on the top surface of the membrane. In still another embodiment, the magnetic-based pinch valve may include a routing layer with a top surface and a bottom surface that may include fluid inlet channels and fluid outlet channels fluidly connected to the pinch valve chamber, and wherein the bottom surface of the routing layer may be mounted on the top surface of the pinch valve layer. In certain embodiments, the magnetic-based pinch valve may include a top substrate with a top surface and a bottom surface that may include at least two fluid ports fluidly connected to the channels of the routing layer, and wherein the bottom surface of the top substrate may be mounted on the top surface of the routing layer.

In yet another embodiment, the magnetic-based pinch valve may include a means for providing a magnetic force to the portion of the membrane held suspended in the free space (s), wherein the means for providing a magnetic force may be arranged relative to the membrane such that application of magnetic force to the membrane may cause the membrane to deflect upward to contact a corresponding surface point on the routing layer, thereby forming a seal to prevent the flow of fluid through the pinch valve chamber, and non-application of magnetic force may cause the membrane to return to a non-deflected state, thereby releasing the seal to allow fluid to flow through the pinch valve chamber.

In certain embodiments, fluid may be able to flow freely into and out of the fluid ports in the top substrate when the membrane may be in a non-deflected state. In yet another embodiment, a portion of the membrane held suspended in free space may be increased in span (s+), wherein a means for providing a moving magnetic force may be arranged relative to the membrane such that application of the moving magnetic force to the membrane may cause the membrane to deflect upward to contact a corresponding surface point on the routing layer to form a seal point and slidingly move along the x-y axial path of the (s+) span of free space and along a corresponding x-y axial path and span of the routing layer to thereby cause fluid in advance of the moving seal point to flow out of the pinch valve chamber towards the fluid output port and fluid trailing the moving seal point to draw fluid into the pinch valve chamber via the fluid input port.

In still another embodiment, sequentially repeating a cycle of moving magnetic force may cause the pinch valve to peristaltically pump fluid through the pinch valve chamber. In yet another embodiment, the magnetic force may be provided by an external magnet that may be arranged to slidingly move along the x-y axial path of the free space of span (s+). In certain embodiments, the pinch valve layer may comprise a material selected from a group consisting of a plastic or glass. In certain embodiments, the pinch valve layer may have a thickness of between about 500 μM to about 3,000 μM. In still another embodiment, the magnetically-responsive flexible membrane may have a thickness of between about 200 μM to about 1,500 μM. In yet still another embodiment, the means for providing a magnetic force may comprise an external magnet.

The invention provides a magnetic-based mixer for use in a microfluidics device. In one embodiment, the magnetic-based mixer may include: (a) a bottom substrate having a top surface and a bottom surface; (b) a first mask layer with top surface and a bottom surface with an opening that may be sized to substantially align with a reaction chamber having a free space of span (s) in a second mask layer, and wherein the bottom surface of the first mask layer may be mounted on the top surface of the bottom substrate; (c) a magnetically-responsive flexible membrane with a top surface and a bottom surface, wherein a portion of the membrane may be held suspended in the free space having a span (s) bounded by the opening in the first mask layer and the reaction chamber in a second mask layer, and wherein the bottom surface of the membrane may be mounted on the top surface of the first mask layer; (d) a second mask layer with a top surface and a bottom surface with a reaction chamber that may be sized to substantially align with the opening in the first mask layer, and wherein the bottom surface of the second mask layer may be mounted on the top surface of the magnetically-responsive flexible membrane; and (e) a top substrate with a top surface and a bottom surface that may include at least two fluid ports fluidly connected to the reaction chamber in the second mask layer and to the opening in the first mask layer, and wherein the bottom surface of the top substrate may be mounted on the top surface of the second mask layer.

In certain embodiments, the magnetic-based mixer may include a first means for providing a magnetic force to the membrane, wherein the first means for providing a magnetic force may be arranged relative to free space of span (s) such that applying a first magnetic force to the free space of span (s) may cause the membrane to deflect upwards to contact a corresponding surface point on the bottom surface of the top substrate, thereby forming a seal to prevent the flow of fluid into (or through) the reaction chamber, and not applying the first magnetic force may cause the membrane to return to a non-deflected state.

In still another embodiment, the magnetic-based mixer may include a second means for providing a magnetic force to the membrane wherein the second means for applying a magnetic force may be arranged relative to the free space of span (s) such that applying a second magnetic force to the free space of span (s) may cause the membrane to deflect downwards to contact a corresponding surface point on the top surface of the bottom substrate, thereby forming a seal to allow the flow of fluid into (or through) the reaction chamber, and not applying the second magnetic force may cause the membrane to return to a non-deflected state. In certain embodiments, repeating a cycle of applying or not applying magnetic force to the membrane may cause fluid mixing in the reaction chamber.

In yet another embodiment, the means for providing a magnetic force may be a rotating magnetic force means, wherein rotation of the rotating magnetic force means may be arranged relative to the membrane such that rotating the magnetic force means around an axis of rotation may cause magnetic force to be applied or not applied to the membrane, wherein the membrane may be caused to alternate between states of deflection and non-deflection and to correspondingly move along an x-y axial path within the free space of span (s), thereby causing a fluid seal formed by the membrane contacting a corresponding surface of the mask layers upon deflection of the membrane to slidingly move along an x-y axial path of a span (s) of the mask layers within the free space of span (s) in synchrony with the movement of the membrane, thereby causing fluid mixing in the reaction chamber.

In certain embodiments, the movement of the membrane along the x-y axial path of span (s) may be a wave-like motion. In still another embodiment, the magnetic-based mixer may include magnetically-responsive surface-attached microposts extending into the reaction chamber. In yet another embodiment, magnetic actuation of the microposts may cause fluid mixing in the reaction chamber. In still another embodiment, the bottom substrate may be a material selected from a group consisting of a plastic or glass. In certain embodiments, the bottom substrate may have a thickness of between about 1,000 μM to about 4,000 μM. In other embodiments, the mask layers may be a material selected from a group consisting of a plastic or glass. In yet other embodiments, the mask layers each may have a thickness of from about 200 μM to about 800 μM. In certain embodiments, the rotating magnetic force means may be an external rotating magnet. In still another embodiment, the bottom substrate may further include a vent fluidly connected to the first mask layer, wherein the vent may control air pressure within the reaction chamber during operation of the mixer. In yet another embodiment, component (c) of the magnetic-based mixer may include a flexible material on which a segment of magnetically-responsive flexible membrane may be bonded, wherein magnetic actuation of the membrane may cause the flexible material to deflect and non-deflect within the reaction chamber to mimic the action of a full layer of membrane. The invention provides a magnetic-based reciprocal pump for use in a microfluidics device.

In one embodiment, the magnetic-based reciprocal pump may include: a bottom substrate having a top surface and a bottom surface; a first mask layer with a top surface and a bottom surface with two openings therethrough that may each be sized to substantially align with a first pumping chamber and a second pumping chamber in a second mask layer, and wherein the bottom surface of the first mask layer may be mounted on the top surface of the bottom substrate; and a magnetically-responsive flexible membrane with a top surface and a bottom surface, that may further include a first portion and a second portion of the membrane each held suspended in a free space having a span (s) bounded by pumping chambers in a second mask layer and the openings in the first mask layer. In certain embodiments, the bottom surface of the membrane may be mounted on the top surface of the first mask layer.

In still another embodiment, the magnetic-based reciprocal pump may include a second mask layer with a top surface and a bottom surface that may include a first pumping chamber and a second pumping chamber that may be sized to substantially align with the openings in the first mask layer and the free spaces of span (s) of the membrane, wherein the first pumping chamber may be bound by the first free space of span (s) of the membrane and a first portion of a bottom surface of a routing layer having a span (s) and the second pumping chamber may be bound by the second free space of span (s) of the membrane and a second portion of the bottom surface of the routing layer having a span (s), wherein a third portion of the second mask layer may be interspaced between the first pumping chamber and the second pumping chamber whereby a top surface of the third portion may form a bottom surface of a reaction chamber, and wherein the bottom surface of the second mask layer may be mounted on the top surface of the membrane

In certain embodiments, the magnetic-based reciprocal pump may include a routing layer with a top surface and a bottom surface with fluid inlet channels and fluid outlet channels fluidly connecting to the pumping chambers in the second mask layer, wherein the first pumping chamber may be bound by a first portion of the bottom surface of the routing layer having a span (s) and the first portion of the top surface of the membrane and the second pumping chamber may be bound by a second portion of the bottom surface of the routing layer having a span (s) and the second portion of the top surface of the membrane, wherein the pumping chambers may be fluidly connecting to an open space that may include a reaction chamber having a top surface and a bottom surface, and wherein the bottom surface of the routing layer may be mounted on the top surface of the second mask layer.

In certain embodiments, the magnetic-based reciprocal pump may include a top substrate with a top surface and a bottom surface that may include at least two fluid ports fluidly connecting to the pumping chambers, wherein a portion of the bottom surface of the top substrate may form the top surface of the reaction chamber, and wherein the bottom surface of the top substrate may be mounted on the top surface of the routing layer.

In still another embodiment, the magnetic-based reciprocal pump may include a first means for providing a magnetic force to the membrane, wherein the first means for providing a magnetic force may be arranged relative to the first free space of span (s) such that application of the magnetic force to the first free space of span (s) may cause the membrane to deflect upwards to contact the first portion with span (s) of the bottom surface of the routing layer, thereby forming a seal to prevent the flow of fluid from the fluid inlet port into the first pumping chamber.

In certain embodiments, the magnetic-based reciprocal pump may include a second means for providing a magnetic force to the membrane, wherein the second means for providing a magnetic force may be arranged relative to the second free space of span (s) such that application of the magnetic force to the second free space of span (s) may cause the membrane to deflect downwards to contact the top surface of the bottom substrate, thereby allowing fluid to flow from the reaction chamber to the fluid outlet port via the second pumping chamber.

In still another embodiment, the magnetic-based reciprocal pump may include a third means for providing a magnetic force to the membrane, wherein the third means for providing a magnetic force may be arranged relative to the first free space of span (s) such that application of the third magnetic force to the first free space of span (s) may cause the membrane to deflect downwards to contact the top surface of the bottom substrate, thereby allowing fluid to flow from the fluid inlet port into the reaction chamber via the first pumping chamber.

In yet another embodiment, the magnetic-based reciprocal pump may include a fourth means for providing a magnetic force to the membrane, wherein the fourth means for providing a magnetic force may be arranged relative to the second free space of span (s) such that application of the fourth magnetic force to the second free space of span (s) may cause the membrane to deflect upwards to contact the second portion of span (s) of the bottom surface of the routing layer, thereby preventing the flow of fluid from the reaction chamber into the second pumping chamber.

In certain embodiments, sequentially repeating a cycle of application and non-application of magnetic force to the membrane may cause the membrane to alternate between states of deflection and non-deflection, thereby causing fluid to flow into and out of the reaction chamber. In still another embodiment, sequentially repeating a cycle of applying and not applying magnetic force via the first, second, third, and fourth means for applying magnetic force may cause a (continuous) reciprocating flow of fluid into and out of the reaction chamber. In certain embodiments, the top surface of the reaction chamber may further include magnetically-responsive surface-attached microposts extending into the reaction chamber. In still another embodiment, the bottom surface of the reaction chamber may further include magnetically-responsive surface-attached microposts extending into the reaction chamber. In certain embodiments, magnetic actuation of the microposts may cause fluid mixing in the reaction chamber. In certain embodiments, the bottom substrate may be a material selected from a group consisting of a plastic or glass. In some embodiments, the bottom substrate may have a thickness of between about 1,000 μM to about 4,000 μM. In certain embodiments, the mask layers may be a material selected from a group consisting of a plastic or glass. In certain embodiments, the mask layers may each have a thickness of from about 200 μM to about 800 μM. In other embodiments, the means for applying magnetic forces may be external magnets. In still other embodiments, the bottom substrate of the magnetic-based reciprocal pump may further include vents fluidly connecting to the first mask layer, wherein the vents may control air pressure within the first and second pumping chambers during operation of the reciprocal pump.

The invention provides a flow-metering device for use in a microfluidics device. In one embodiment, the flow-metering device may include: a bottom substrate having a top surface and a bottom surface and a flexible membrane having a top surface and a bottom surface, wherein the bottom substrate and the flexible membrane may be separated by spacers having an inner surface and an outer surface, wherein the spacers may separate the top surface of the bottom substrate and the bottom surface of the flexible membrane thereby forming a flow chamber bounded by the top surface of the bottom substrate, the bottom surface of the flexible membrane, and the inner surface of the spacers, and wherein the flow chamber may have an initial size and volume; fluid inlet ports and fluid outlet ports in the substrate fluidly connecting to the flow chamber; and a pumping force means, wherein the pumping force means for providing pumping force may be arranged relative to the flow chamber such that applying the pumping force may cause fluid to flow into and out of the flow chamber.

In certain embodiments, the bottom substrate may be a rigid substrate. In yet another embodiment, flexing the flexible membrane towards the bottom substrate may cause the flow chamber to have a decreased size and volume compared to its initial size and volume. In certain embodiments, flexing the flexible membrane away from the bottom substrate may cause the flow chamber to have an increased size and volume compared to its initial size and volume. In still another embodiment, the flow-metering device may further include a flexing force means for flexing the flexible membrane, wherein the flexing force means may be arranged relative to the flexible membrane such that flexing the flexible membrane may cause the flow chamber to decrease in size and volume compared to its initial size and volume or to increase in size and volume compared to its initial size and volume. In certain embodiments, the flexible membrane may be magnetically-responsive, and wherein applying or not applying a magnetic force to the flexible membrane may cause flexing of the flexible membrane. In other embodiments, the flexible membrane may be a flexible material doped with magnetically-responsive material, wherein application of a magnetic force to the magnetically-responsive material may cause flexing of the flexible material. In still other embodiments, application of a magnetic force to a top surface and/or a bottom surface of a magnetically-responsive flexible membrane may cause the membrane to flex away from and/or towards the bottom substrate.

In certain embodiments, the flexible material may be selected from a group consisting of silicone, hydrogel, polydimethylsiloxane (PDMS), a thermoplastic elastomer, and a fluoropolymer. In yet other embodiments, the flexible membrane may have a thickness of between about 200 μM to about 1,500 μM. In still other embodiments, the magnetically-responsive material may be selected from a group consisting of iron (Fe), nickel (Ni), cobalt (Co), ferroferric oxide (Fe₃O₄), barium hexaferrite (BaFe₁₂O₁₉), cobalt(II) oxide (CoO), nickel(II) oxide (NiO), manganese(III) oxide (Mn₂O₃), chromium(III) oxide (Cr₂O₃), and cobalt manganese phosphide (CoMnP). In certain embodiments, the magnetic force may be applied by an external magnet. In other embodiments, the pumping force means may be an external pump, wherein the pump may control the amount of fluid in the flow chamber.

The invention provides a microfluidics system. In one embodiment, the microfluidics system may include a magnetically-responsive element that may include fluid input and fluid output ports or valves; a microfluidics cartridge that may include fluid input and fluid output channels for fluidly connecting to the fluid input and fluid output ports or valves of the magnetically-responsive element; a controller for controlling the operation of the magnetically-responsive element and the microfluidics cartridge connected to the magnetically-responsive element and the microfluidics cartridge; and wherein the magnetically-responsive element may be sized to engagingly fit within the microfluidics cartridge. In other embodiments, the magnetically-responsive element may be selected from a group consisting of a magnetic-based pinch valve of the invention, a magnetic-based peristaltic pump of the invention, a magnetic-based mixer of the invention, a magnetic-based reciprocal pump of the invention, and a flow-metering device of the invention.

### BRIEF DESCRIPTION OF THE DRAWINGS

The accompanying drawings, which are incorporated in and constitute a part of this specification, illustrate certain embodiments, and together with the written description, serve to explain certain principles of the methods, devices and systems disclosed herein. The drawings are included by way of example and not by way of limitation. Like reference numerals identify like components throughout the drawings unless the context indicates otherwise. Some or all of the figures may be schematic representations.

FIG. 1 illustrates side views of an example of a flow/mixer device including a flexible membrane and magnetically responsive surface-attached microposts.

FIG. 2 illustrates side views showing an example of a membrane actuator for use with the flow/mixer device including a flexible membrane and magnetically responsive surface-attached microposts.

FIG. 3 illustrates side views showing an example of a microposts actuator for use with the flow/mixer device including a flexible membrane and magnetically responsive surface-attached microposts.

FIG. 4A and FIG. 4B illustrate side views of an example of microposts of the presently disclosed microfluidics device;

FIG. 5A and FIG. 5B illustrate side views of a micropost and show examples of the actuation motion thereof;

FIG. 6 through FIG. 10 illustrate side views of other examples of flow/mixer devices including a flexible membrane and magnetically responsive surface-attached microposts;

FIG. 11 shows an example of a process of using the presently disclosed flow/mixer device for fluid pumping and/or mixing.

FIG. 12 shows an example of a process of using the presently disclosed flow/mixer device for fluid metering and/or mixing.

FIG. 13 illustrates a top view of another example of a flow/mixer device that includes two inlets and one outlet.

FIG. 14 illustrates a side view of an example of an integrated structure including the presently disclosed flow/mixer device including a flexible membrane and magnetically responsive surface-attached microposts.

FIG. 15A and FIG. 15B illustrate a perspective view and side views, respectively, of an example of a magnetically responsive flexible membrane.

FIG. 16 illustrates an exploded view of an example of a magnetically responsive pinch valve including a magnetically responsive flexible membrane.

FIG. 17A and FIG. 17B illustrate cross-sectional views of a portion of the magnetically responsive pinch valve shown in FIG. 16 in a non-actuated and actuated states, respectively.

FIG. 18 is a flow diagram of an example of a method of operation of the magnetically responsive flexible membrane in, for example, a microfluidic device.

FIG. 19A and FIG. 19B illustrate side views of the magnetically responsive pinch valve shown in FIG. 16 in the open and closed states, respectively.

FIG. 20 through FIG. 23 illustrate side views of an example of a magnetically responsive peristaltic pump including a magnetically responsive flexible membrane.

FIG. 24 illustrates an exploded view of an example of a magnetically responsive single-chamber mixer including a magnetically responsive flexible membrane.

FIG. 25 through FIG. 34B illustrate side views of the magnetically responsive single-chamber mixer shown in FIG. 24 and showing processes of using and various useful features thereof.

FIG. 35 through FIG. 38 illustrate side views of an example of a magnetically responsive two-chamber reciprocal pump including a magnetically responsive flexible membrane.

FIG. 39 illustrates a side view of an example of a magnetically responsive flow metering device including a magnetically responsive flexible membrane.

### DEFINITIONS

“Active surface” means any surface or area that can be used for processing samples. The active surface can be inside a reaction or assay chamber. For example, the active surface can be any surface that has properties designed to manipulate the fluid inside the chamber.

“Sample” means a source of cells for culturing or biomolecular analysis. Examples include biological materials, fluids, environmental samples (e.g., water samples, air samples, soil samples, solid and fluid wastes, and animal and vegetable tissues), and industrial samples (e.g., food, reagents, and the like).

“Manipulation” means causing a physical change in a liquid, such as a cell sample. Examples include generating fluid flow, altering the flow profile of an externally driven fluid, fractionating the sample into constituent parts, establishing or eliminating concentration gradients within the chamber, and the like. Examples of surface properties useful for manipulation include post technology—whether static or actuated (i.e., activated). The surface properties may also include microscale texture or topography in the surface, physical perturbation of the surface by vibration or deformation; electrical, electronic, electromagnetic, and/or magnetic system on or in the surface; optically active (e.g., lenses) surfaces, such as embedded light-emitting diodes (LEDs) or materials that interact with external light sources; and the like.

“Surface-attached post” or “surface-attached micropost” or “surface-attached structure” or “micropost” are used interchangeably. Generally, a surface-attached structure has two opposing ends: a fixed end and a free end. The fixed end may be attached to a substrate by any suitable means, depending on the fabrication technique and materials employed. The fixed end may be “attached” by being integrally formed with or adjoined to the substrate, such as by a microfabrication process. Alternatively, the fixed end may be “attached” via a bonding, adhesion, fusion, or welding process. The surface-attached structure has a length defined from the fixed end to the free end, and a cross-section lying in a plane orthogonal to the length. For example, using the Cartesian coordinate system as a frame of reference, and associating the length of the surface-attached structure with the z-axis (which may be a curved axis), the cross-section of the surface-attached structure lies in the x-y plane.

The cross-section of the surface-attached structure may have any shape, such as rounded (e.g., circular, elliptical, etc.), polygonal (or prismatic, rectilinear, etc.), polygonal with rounded features (e.g., rectilinear with rounded corners), or irregular. The cross-section may be symmetrical or asymmetrical. The size of the cross-section of the surface-attached structure in the x-y plane may be defined by the “characteristic dimension” of the cross-section, which is shape-dependent. As examples, the characteristic dimension may be diameter in the case of a circular cross-section, major axis in the case of an elliptical cross-section, or maximum length or width in the case of a polygonal cross-section. The characteristic dimension of an irregularly shaped cross-section may be taken to be the dimension characteristic of a regularly shaped cross-section that the irregularly shaped cross-section most closely approximates (e.g., diameter of a circle, major axis of an ellipse, length or width of a polygon, etc.).

A surface-attached structure as described herein may be non-movable (static, rigid, etc.) or movable (flexible, deflectable, bendable, etc.) relative to its fixed end or point of attachment to the substrate. To facilitate the movability of movable surface-attached structures, the surface-attached structure may include a flexible body composed of an elastomeric (flexible) material and may have an elongated geometry in the sense that the dominant dimension of the surface-attached structure is its length—that is, the length is substantially greater than the characteristic dimension. Examples of the composition of the flexible body include, but are not limited to, elastomeric materials such as hydrogel and other active surface materials (for example, polydimethylsiloxane (PDMS)).

The movable surface-attached structure is configured such that the movement of the surface-attached structure relative to its fixed end may be actuated or induced in a non-contacting manner by an actuation force. For example, to render the surface-attached structure movable by an applied magnetic or electric field, the surface-attached structure may include an appropriate metallic component disposed on or in the flexible body of the surface-attached structure. To render the surface-attached structure responsive to a magnetic field, the metallic component may be a ferromagnetic material such as, for example, iron, nickel, cobalt, or magnetic alloys thereof, one non-limiting example being “alnico” (an iron alloy containing aluminum, nickel, and cobalt). To render the surface-attached structure responsive to an electric field, the metallic component may be a metal exhibiting electrical conductivity such as, for example, copper, aluminum, gold, and silver, and various other metals and metal alloys. Depending on the fabrication technique utilized, the metallic component may be formed as a layer (or coating, film, etc.) on the outside surface of the flexible body at a selected region of the flexible body along its length. The layer may be a continuous layer or a densely grouped arrangement of particles. Alternatively, the metallic component may be formed as an arrangement of particles embedded in the flexible body at a selected region thereof.

“Actuation force” means the force applied to the microposts. For example, the actuation force may include a magnetic, thermal, sonic, or electric force. Notably, the actuation force may be applied as a function of frequency or amplitude, or as an impulse force (i.e., a step function). Similarly, other actuation forces may be used without departing from the scope of the present subject matter, such as fluid flow across the micropost array (e.g., flexible microposts that are used as flow sensors via monitoring their tilt angle with an optical system). In one example, the actuation force is an applied magnetic or electric field of a desired strength, field line orientation, and frequency (which may be zero in the case of a magnetostatic or electrostatic field).

Application of an actuation force actuates the movable surface-attached microposts into movement. For example, the actuation may occur by contacting a cell processing chamber with a control instrument comprising elements that provide an actuation force, such as a magnetic or electric field. Accordingly, the control instrument includes, for example, any mechanisms for actuating the microposts (e.g., magnetic system), any mechanisms for counting the cells (e.g., imaging system), the pneumatics for pumping the fluids (e.g., pumps, fluid ports, valves), and a controller (e.g., microprocessor).

“Flow cell” is any chamber comprising a solid surface across which one or more fluids can be flowed, wherein the chamber has at least one inlet and at least one outlet.

“Micropost field” or “micropost array” refers to an array of small posts, extending outwards from a substrate, that typically range from 1 to 100 micrometers in height. In one embodiment, microposts of a micropost array may be vertically-aligned. Notably, each micropost includes a proximal end that is attached to the substrate base and a distal end or tip that is opposite the proximal end. Microposts may be arranged in arrays such as, for example, the microposts described in U.S. Pat. No. 9,238,869, entitled “Methods and systems for using actuated surface-attached posts for assessing biofluid rheology,” issued on Jan. 19, 2016; the entire disclosure of which is incorporated herein by reference. U.S. Pat. No. 9,238,869 describes methods, systems, and computer readable media for using actuated surface-attached posts for assessing biofluid rheology. One method described in U.S. Pat. No. 9,238,869 is directed to testing properties of a biofluid specimen that includes placing the specimen onto a micropost array having a plurality of microposts extending outwards from a substrate, wherein each micropost includes a proximal end attached to the substrate and a distal end opposite the proximal end, and generating an actuation force in proximity to the micropost array to actuate the microposts, thereby compelling at least some of the microposts to exhibit motion. This method further includes measuring the motion of at least one of the microposts in response to the actuation force and determining a property of the specimen based on the measured motion of the at least one micropost.

U.S. Pat. No. 9,238,869 also states that the microposts and micropost substrate of the micropost array can be formed of polydimethylsiloxane (PDMS). Further, microposts may include a flexible body and a metallic component disposed on or in the body, wherein application of a magnetic or electric field actuates the microposts into movement relative to the surface to which they are attached (e.g., wherein the actuation force generated by the actuation mechanism is a magnetic and/or electrical actuation force).

“Magnetically responsive” means responsive to a magnetic field. “Magnetically responsive microposts” include or are composed of magnetically responsive materials. Examples of magnetically responsive materials include, but are not limited to, paramagnetic materials, ferromagnetic materials, ferrimagnetic materials, and metamagnetic materials. Examples of suitable paramagnetic materials include iron, nickel, and cobalt, as well as metal oxides, such as, but not limited to, ferroferric oxide (Fe₃O₄), barium hexaferrite (BaFe₁₂O₁₉), cobalt(II) oxide (CoO), nickel(II) oxide (NiO), manganese(III) oxide (Mn₂O₃), chromium(III) oxide (Cr₂O₃), and cobalt manganese phosphide (CoMnP).

“Micropost field” or “micropost array” means a field or an array of small posts, extending outwards from a substrate. The posts typically range from about 1 to about 100 micrometers in height.

The terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact but may be approximate and/or larger or smaller as desired, reflecting tolerances, conversion factors, rounding off, measurement error and the like, and other factors known to those of skill in the art depending on the desired properties sought to be obtained by the invention. Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### DETAILED DESCRIPTION

The invention provides microfluidic devices and methods including flexible membranes and/or magnetically-responsive elements. In one example, the microfluidic devices and methods include or make use of a flexible membrane having magnetically-responsive surface-attached microposts thereon. In another example, the microfluidic devices and methods include or make use of a magnetically-responsive flexible membrane. In yet another example, the microfluidic devices and methods include both magnetically-responsive surface-attached microposts and a magnetically-responsive flexible membrane.

In some embodiments, the presently disclosed microfluidic devices and methods provide a flow/mixer device including a flexible membrane having magnetically-responsive surface-attached microposts thereon and wherein the flexible membrane may be used, for example, for pumping and/or metering fluid and wherein the magnetically-responsive surface-attached microposts may be used for mixing.

In some embodiments, the presently disclosed microfluidic devices and methods provide a magnetically-responsive flexible membrane that may be utilized in, for example, a microfluidics device for any purpose, such as, but not limited to, pumping, mixing, and/or metering and wherein the magnetically-responsive flexible membrane may be deflected in a controlled manner using a magnet force.

In some embodiments, the presently disclosed microfluidic devices and methods provide a magnetically-responsive valve that includes a magnetically-responsive flexible membrane that may be actuated via a magnetic force to open and close the valve.

In some embodiments, the presently disclosed microfluidic devices and methods provide a magnetically-responsive peristaltic pump that includes a magnetically-responsive flexible membrane that may be actuated via a magnetic force to perform the pumping action.

In some embodiments, the presently disclosed microfluidic devices and methods provide a magnetically-responsive single-chamber mixer device that includes a magnetically-responsive flexible membrane that may be actuated via a magnetic force to compel the magnetically-responsive flexible membrane to exhibit motion and thereby provide mixing action within the chamber.

In some embodiments, the presently disclosed microfluidic devices and methods provide a magnetically-responsive single-chamber mixer device that includes both a magnetically-responsive flexible membrane and magnetically-responsive surface-attached microposts that may be actuated via a magnetic force to provide mixing action within the chamber.

In some embodiments, the presently disclosed microfluidic devices and methods provide a magnetically-responsive two-chamber reciprocal pump device that includes a magnetically-responsive flexible membrane that may be actuated via a magnetic force to perform the reciprocal pumping action.

In some embodiments, the presently disclosed microfluidic devices and methods provide a magnetically-responsive flow metering device that includes a magnetically-responsive flexible membrane that may be actuated to restrict the flow of fluid through a flow chamber in a controlled manner.

In some embodiments, the presently disclosed microfluidic devices and methods including flexible membranes and/or magnetically-responsive elements may be mass produced using any large-scale manufacturing process, such as a wafer-level manufacturing process.

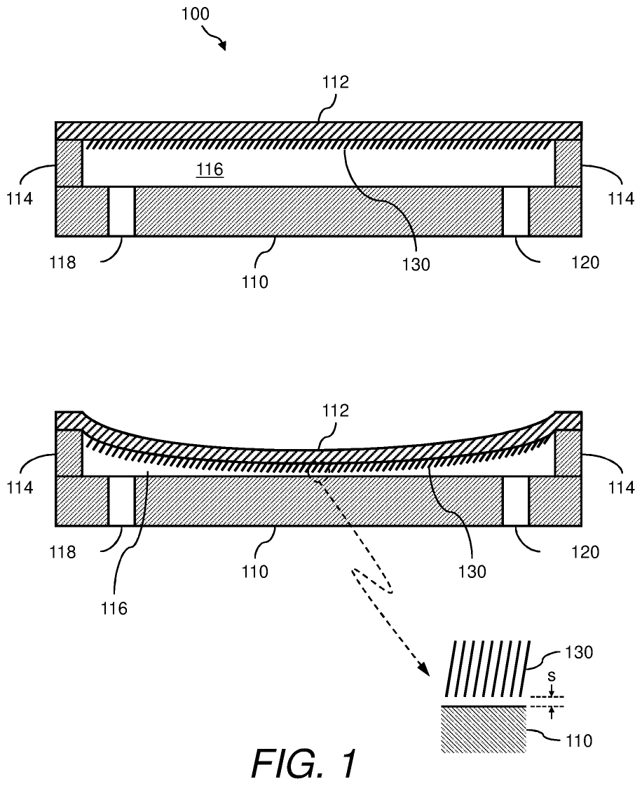

FIG. 1 illustrates side views of an example of a cross-section of a flow/mixer device 100 including a flexible membrane and magnetically-responsive surface-attached microposts. Flow/mixer device 100 is an example of the microfluidic devices and methods including flexible membranes and/or magnetically-responsive elements. Flow/mixer device 100 may include, for example, a substrate 110, which may be rigid or flexible, with a top and a bottom surface and a flexible membrane 112 with a top and a bottom surface separated by spacers 114 to form a flow chamber 116. That is, the substrate 110 and the flexible membrane 112 are separated by spacers 114 having an inner surface and an outer surface, wherein the spacers 114 separate the top surface of the substrate 110 and the bottom surface of the flexible membrane 112 thereby forming a flow chamber 116 bounded by the top surface of the substrate 110, the bottom surface of the flexible membrane 112, and the inner surface of the spacers 114, and wherein the flow chamber 116 has an initial size and volume; and fluid inlet ports 118 and fluid outlet ports 120 in the substrate 110 fluidly connecting to the flow chamber 116.

In this example, substrate 110 may be a substantially flat rigid surface. Rigid substrate 110 and spacers 114 may be formed, for example, of plastic or glass. Further, rigid substrate 110 may have an inlet 118 and an outlet 120.

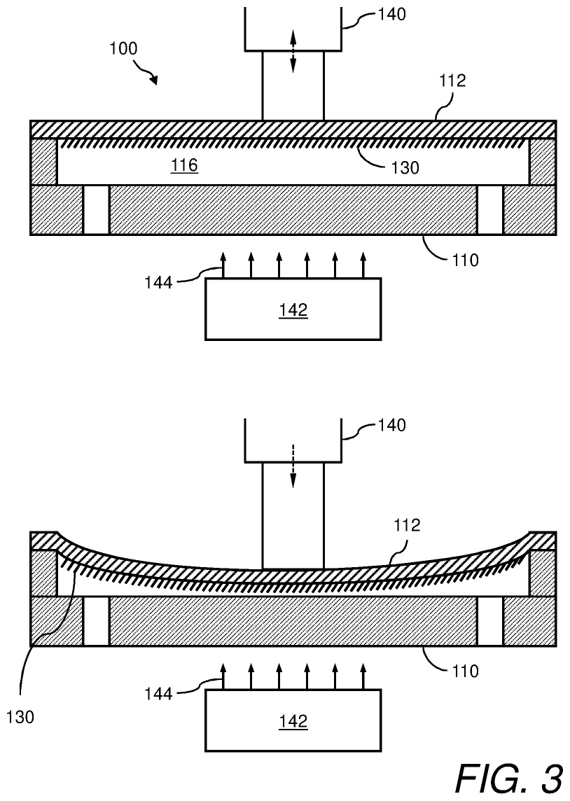

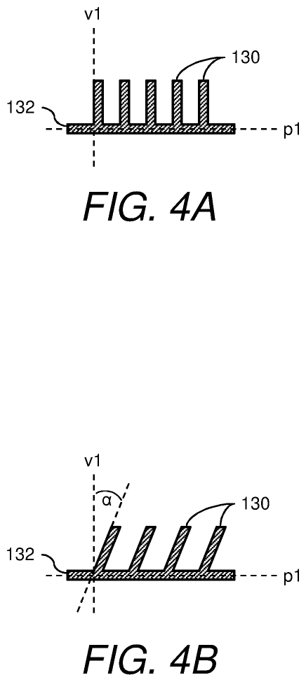

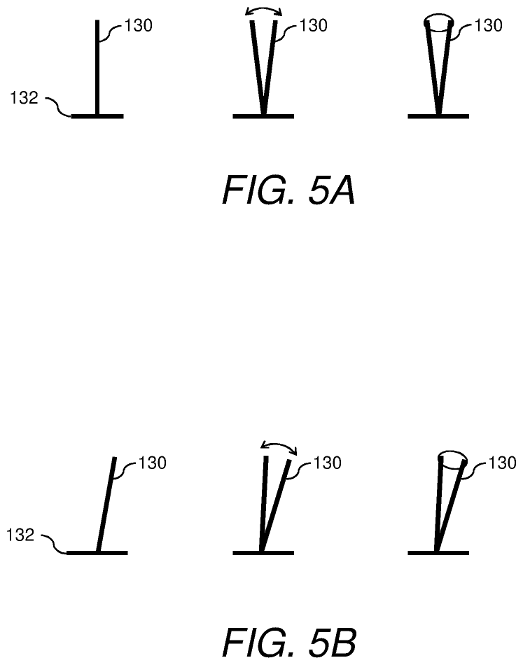

A field or array of magnetically-responsive surface-attached microposts 130 may be provided on the surface of flexible membrane 112 facing (or extending) into flow chamber 116. Flexible membrane 112 may be formed of an elastomeric (flexible) material, such as, but not limited to, hydrogel, polydimethylsiloxane (PDMS), and the like. In one example, flexible membrane 112 may be from about 200 μm to about 1,500 μm thick. Further, magnetically-responsive surface-attached microposts 130 may be formed of the same elastomeric (flexible) material (e.g., hydrogel, PDMS) that is doped with a magnetically-responsive element, e.g., iron (Fe), nickel (Ni), or cobalt (Co), as well as a metal oxide. Accordingly, a magnetically-responsive actuation mechanism (see FIG. 3) may be arranged in close proximity to flow/mixer device 100. The actuation mechanism may be used to generate an actuation force in proximity to microposts 130 that compels at least some of microposts 130 to exhibit motion. More details of magnetically-responsive surface-attached microposts 130 are shown and described hereinbelow with reference to FIG. 4A through FIG. 5B.

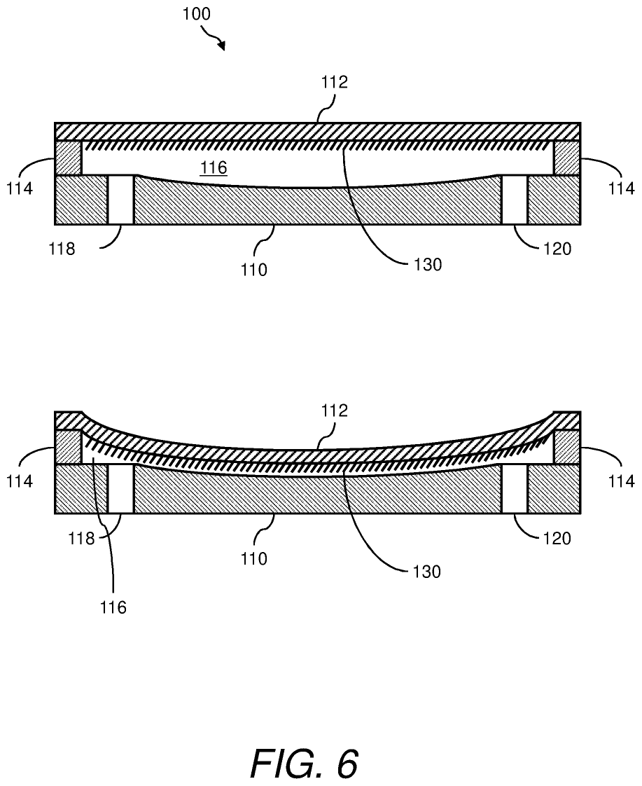

FIG. 1 shows flow/mixer device 100 in two states: (1) with flexible membrane 112 not deflected (top) and (2) with flexible membrane 112 deflected toward rigid substrate 110 (bottom), but without magnetically-responsive surface-attached microposts 130 touching rigid substrate 110. For example, to reduce the probability of damage to magnetically-responsive surface-attached microposts 130, when flexible membrane 112 is deflected, a certain distance (e.g., a few microns) is maintained between the tips of microposts 130 and the surface of rigid substrate 110. Further, the dimensions of flow chamber 116 may depend on the allowable span and deflection distance of flexible membrane 112, which may be based on the characteristics of the material forming flexible membrane 112. Other variations of flow/mixer device 100 are shown and described hereinbelow with reference to FIG. 6 through FIG. 13.

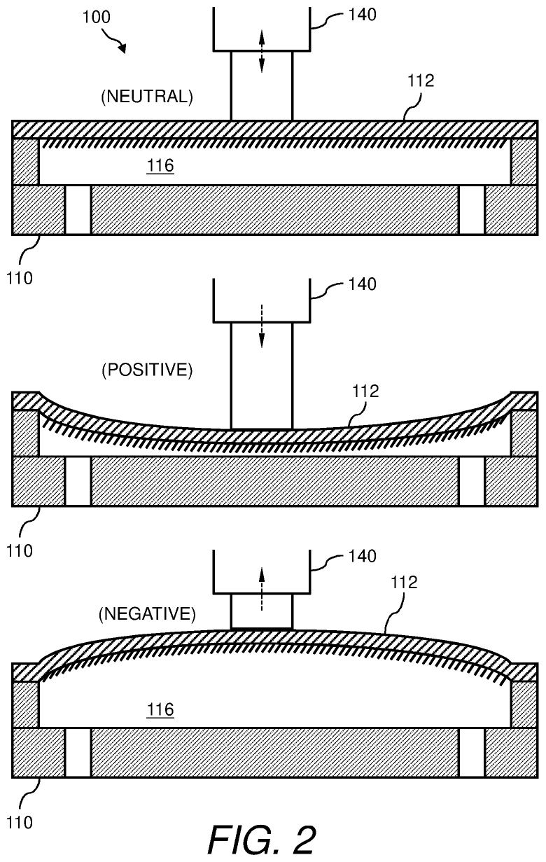

A means for providing an actuation force, e.g., an actuation mechanism, may be arranged in contact with flexible membrane 112 for actuating flexible membrane 112 up and down. For example, FIG. 2 shows side views of an example of a membrane actuator 140 for use with flexible membrane 112 of flow/mixer device 100. Membrane actuator 140 may be, for example, a solenoid and piston mechanism or a pneumatic mechanism coupled to flexible membrane 112 that can be used to drive it up or down. For example, in a “neutral” or unflexed (or non-deflected or relaxed) position, the flexible membrane 112 may be substantially flat across flow chamber 116 (i.e., flexible membrane 112 has a flat topological shape). In a “positive” or deflected (or flexed) position, the flexible membrane 112 may be pushed or deflected inward (or downward) toward rigid substrate 110 of flow/mixer device 100. In a “negative” or deflected (or flexed) position, the flexible membrane 112 may be pulled or deflected outward away from rigid substrate 110 of flow/mixer device 100.

FIG. 3 illustrate cross-sectional side views showing an example of a magnetic actuation mechanism 142 for use with the magnetically-responsive surface-attached microposts 130 of flow/mixer device 100. Magnetic actuation mechanism 142 is arranged in close proximity to flow/mixer device 100 that has the field of microposts 130. Magnetic actuation mechanism 142 generates an actuation force 144. As used herein, the term “actuation force” refers to the force applied to microposts 130. Magnetic actuation mechanism 142 may be used to generate an actuation force in proximity to microposts 130 that compels at least some of microposts 130 to exhibit motion. The actuation force may be, for example, magnetic, thermal, sonic, and/or electric force. Further, the actuation force may be applied as a function of frequency or amplitude, or as an impulse force (i.e., a step function). Similarly, other actuation forces may be used without departing from the scope of the present subject matter, such as fluid flow across the field of microposts 130. In this example, because microposts 130 are magnetically-responsive microposts, then actuation force 144 is a magnetic actuation force. Magnetic actuation mechanism 142 may be one of the magnetic-based actuation mechanisms described with reference to U.S. Patent App. No. 62/654,048, entitled “Magnetic-Based Actuation Mechanisms for and Methods of Actuating Magnetically Responsive Microposts in a Reaction Chamber,” filed on Apr. 16, 2018.

FIG. 4A and FIG. 4B are side views of an example of microposts 130 arranged in a micropost field or array on a substrate 132. In one embodiment, microposts of a micropost field or array are substantially vertical along a line v1 relative to a plane p1 established by substrate 132. Notably, each micropost includes a proximal end that is attached to substrate 132 and a distal end or tip that is opposite the proximal end. Accordingly, at least one surface of flow chamber 116 of flow/mixer device 100 may include an arrangement of microposts 130 on substrate 132.

Microposts 130 and substrate 132 can be formed, for example, of PDMS. The length, diameter, geometry, orientation, and pitch of microposts 130 in the field or array can vary. For example, the length of microposts 130 can vary from about 1 μm to about 100 μm. The diameter of microposts 130 can vary from about 0.1 μm to about 10 μm. Further, the cross-sectional shape of microposts 130 can vary. For example, the cross-sectional shape of microposts 130 can be circular, ovular, square, rectangular, triangular, and so on. The orientation of microposts 130 can vary. For example, FIG. 4A shows microposts 130 having an axis along line v1 that is oriented substantially normal to the plane p1 of substrate 132, while FIG. 4B shows microposts 130 oriented at a tilt angle α with respect to the normal of the plane p1 of substrate 132. In a neutral position with no actuation force applied, the tilt angle α can be, for example, from about 0 degrees to about 45 degrees. Additionally, the pitch of microposts 130 within a micropost field or array can vary, for example, from about 0 μm to about 50 μm. Further, the relative positions of microposts 130 within the micropost field or array can vary, and the microposts can have a regular or irregular pitch. Where the pitch of microposts 130 within a micropost field or array is irregular, the pitch within the irregular array can vary for example, from about 0 μm to about 50 μm.

FIG. 5A and FIG. 5B illustrate cross-sectional side views of a micropost 130 and show examples of the actuation motion thereof. For example, FIG. 5A shows an example of a micropost 130 oriented substantially normal to the plane of substrate 132 (see FIG. 4A). FIG. 5A shows that the distal end of the micropost 130 can move (1) with side-to-side 2D motion only with respect to the fixed proximal end or (2) with circular (or conical) motion with respect to the fixed proximal end, which is a cone-shaped motion. By contrast, FIG. 5B shows an example of a micropost 130 oriented at an angle with respect to the plane of substrate 132 (see FIG. 4B). FIG. 5B shows that the distal end of the micropost 130 can move (1) with tilted side-to-side 2D motion only with respect to the fixed proximal end or (2) with tilted circular motion with respect to the fixed proximal end, which is a tilted cone-shaped motion (or tilted conical motion).

In flow/mixer device 100 and/or any of the presently disclosed microfluidic devices and methods including flexible membranes and/or magnetically responsive elements, by actuating microposts 130 and causing motion thereof, any fluid in a chamber is in effect stirred or caused to flow or circulate within the chamber and across the surface area thereof. Further, the cone-shaped motion of micropost 130 shown in FIG. 5A, as well as the tilted cone-shaped motion of micropost 130 shown in FIG. 5B, can be achieved using a rotating magnetic field. A rotating magnetic field is one example of actuation force 144 of magnetic actuation mechanism 142 shown in FIG. 3. Further, magnetic actuation mechanism 142 may be configured to actuate the magnetically responsive surface-attached microposts 130 in certain beat patterns, such as synchronized beat patterns and/or metachronal beat patterns.

FIG. 1 through FIG. 5B show microposts 130. Microposts 130 may be based on, for example, the microposts described in the '869 patent as described hereinabove. In one example, according to the '869 patent, microposts 130 and substrate 132 can be formed of PDMS. Further, microposts 130 may include a flexible body and a metallic component disposed on or in the body, wherein application of a magnetic or electric field actuates microposts 130 into movement relative to the surface to which they are attached. Again, in the presently disclosed microfluidic devices and methods including flexible membranes and/or magnetically responsive elements, actuation force 144 generated by magnetic actuation mechanism 142 may be a magnetic actuation force. Accordingly, the magnetically responsive surface-attached microposts 130 are positioned within the magnetic actuation force 144 generated by magnetic actuation mechanism 142.

FIG. 6 through FIG. 10 illustrate cross-sectional side views of other examples of flow/mixer devices 100 including flexible membrane 112 and magnetically-responsive surface-attached microposts 130. FIG. 6 shows an example of flow/mixer device 100 in which rigid substrate 110 has a bowl-shaped (or bowl-like) topology. In this example, the bowl-shaped (or bowl-like) topology of rigid substrate 110 may substantially correspond to the topology of flexible membrane 112 when deflected inward (or downward) toward rigid substrate 110.

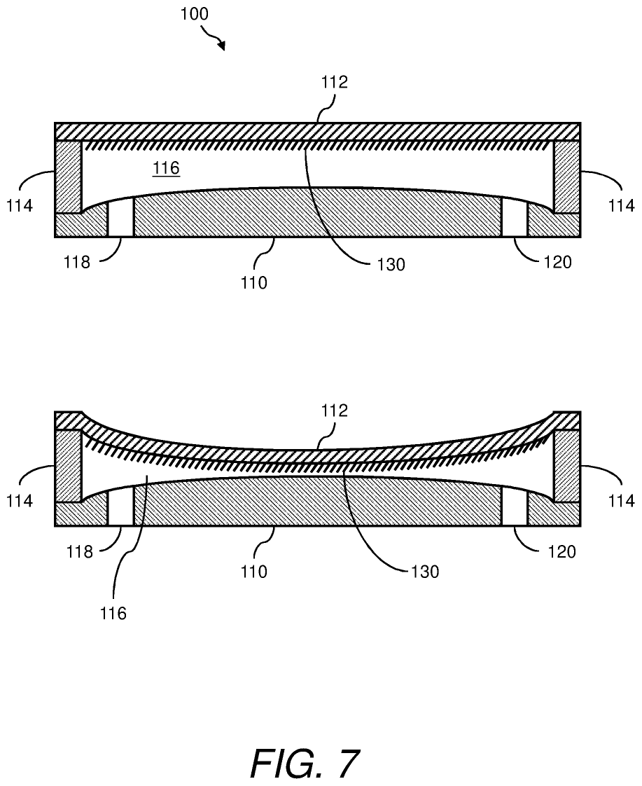

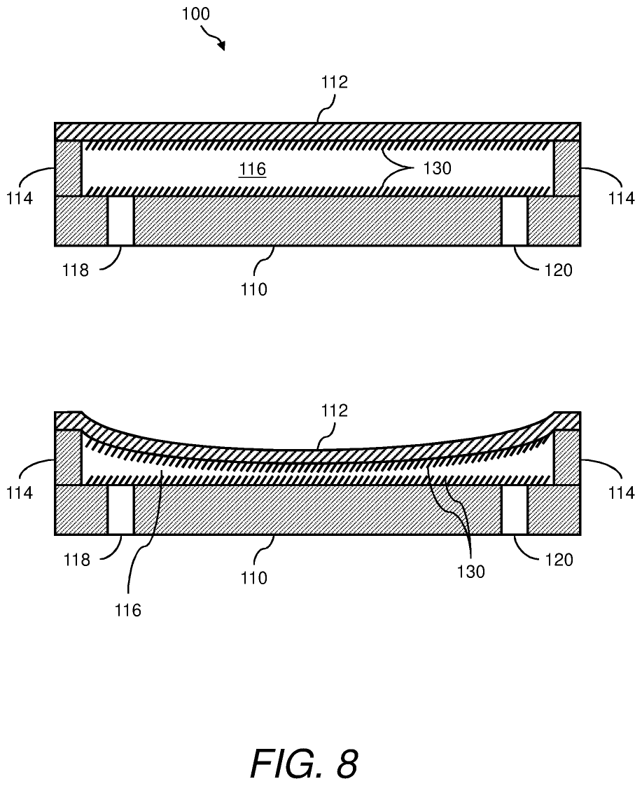

FIG. 7 shows an example of flow/mixer device 100 in which rigid substrate 110 has a dome-shaped (or dome-like) topology. FIG. 8 shows an example of flow/mixer device 100 in which magnetically-responsive surface-attached microposts 130 are on both flexible membrane 112 and rigid substrate 110. While rigid substrate 110 is shown flat, rigid substrate 110 may have any topology.

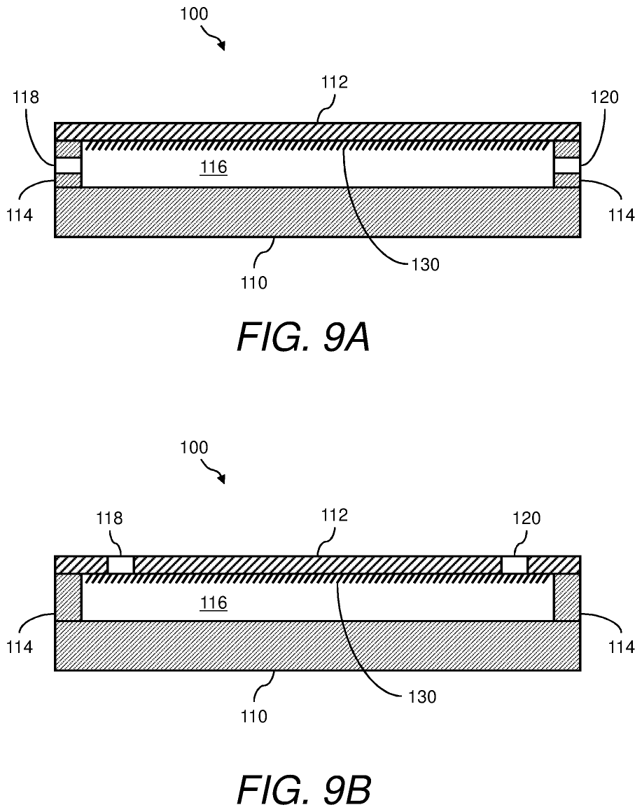

FIG. 9A and FIG. 9B show examples of other fluid port locations in flow/mixer device 100. FIG. 9A shows an example of flow/mixer device 100 in which inlet 118 and outlet 120 are provided in spacers 114 instead of in rigid substrate 110. FIG. 9B shows an example of flow/mixer device 100 in which inlet 118 and outlet 120 are provided in flexible membrane 112 instead of in rigid substrate 110. In this example, a flexible and robust coupling to inlet 118 and outlet 120 may be needed to allow movement without detaching.

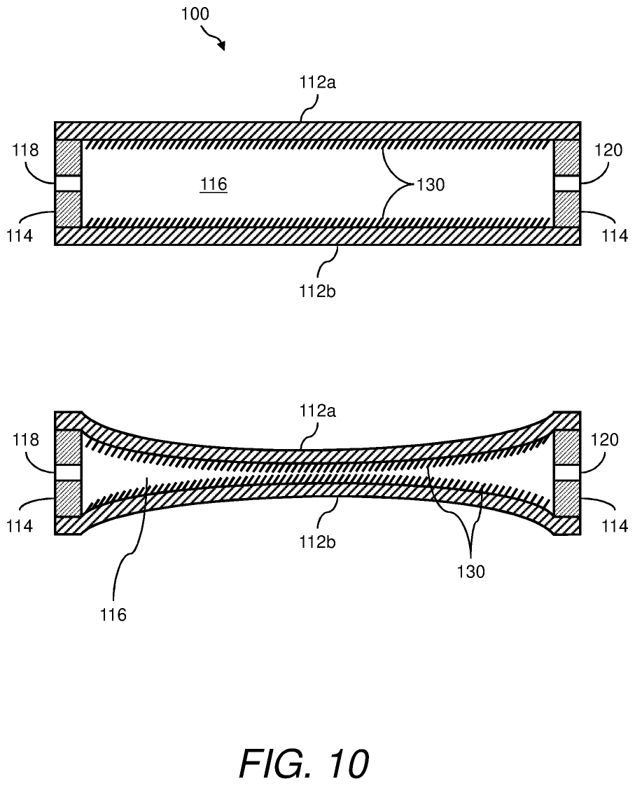

FIG. 10 shows an example of flow/mixer device 100 in which rigid substrate 110 is replaced with a second flexible membrane 112 with a top and a bottom surface and with inlet 118 and outlet 120 in spacers 114. In this example, magnetically-responsive surface-attached microposts 130 may be provided on one or both flexible membranes 112. In any of the examples of flow/mixer device 100 shown in FIG. 1 through FIG. 10, when flexible membrane 112 is deflected inward (or downward), the distance (space “s”) (see FIG. 1) is maintained between microposts 130 and any opposing structure, member, element, and/or component of flow/mixer device 100.

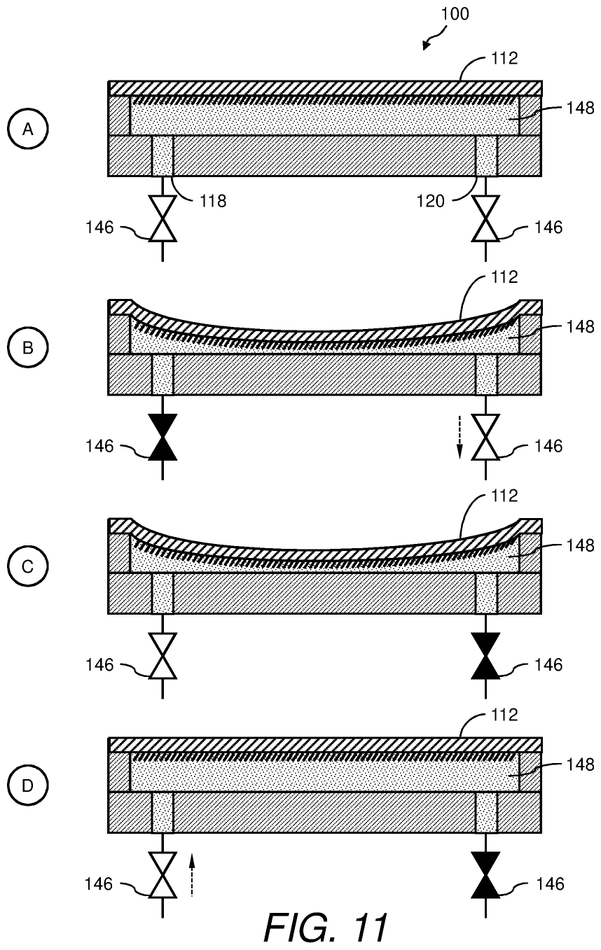

The presently disclosed flow/mixer device 100 may be used for various purposes. In one example, FIG. 11 shows an example of a process of using flow/mixer device 100 for fluid pumping and/or mixing. In this example, valves 146 may be provided at inlet 118 and outlet 120. For example, an inlet valve 146 is in the flow path at inlet 118 and an outlet valve 146 is in the flow path at outlet 120. This fluid pumping and/or mixing process may include, but is not limited to, the following steps.

In a step A, both inlet valve 146 and outlet valve 146 are open and flexible membrane 112 is in the “neutral” or unflexed or non-deflected state (see FIG. 2) under the control of membrane actuator 140 (not shown; see FIG. 2), which allows flow chamber 116 to be filled with a fluid 148. Fluid 148 may be any fluid, such as a sample fluid, a reagent, or both, to be processed in flow/mixer device 100. Further, in this step, using magnetic actuation mechanism 142 (not shown; see FIG. 3), the magnetically-responsive surface-attached microposts 130 may be actuated to provide mixing action or not actuated for no mixing action.

In a step B, inlet valve 146 is closed and outlet valve 146 is open. Then, using membrane actuator 140 (see FIG. 2), flexible membrane 112 is placed in the “positive” or flexed or deflected state (see FIG. 2), which forces or pumps fluid 148 out of outlet 120 of flow chamber 116 and outlet valve 146. Further, in this step, using magnetic actuation mechanism 142 (see FIG. 3), the magnetically-responsive surface-attached microposts 130 may be actuated to provide mixing action or not actuated for no mixing action.

In a step C, using membrane actuator 140 (see FIG. 2), flexible membrane 112 is held in the “positive” state (see FIG. 2), then inlet valve 146 is opened and outlet valve 146 is closed. Further, in this step, using magnetic actuation mechanism 142 (see FIG. 3), the magnetically-responsive surface-attached microposts 130 may be actuated to provide mixing action or not actuated for no mixing action.

In a step D, with inlet valve 146 opened and outlet valve 146 closed, membrane actuator 140 (see FIG. 2) may be used to return flexible membrane 112 to the “neutral” (unflexed) state (see FIG. 2), which draws fluid 148 through inlet valve 146 and inlet 118 and refills flow chamber 116. Further, in this step, using magnetic actuation mechanism 142 (see FIG. 3), the magnetically-responsive surface-attached microposts 130 may be actuated to provide mixing action or not actuated for no mixing action. Then, steps B, C, and D may be sequentially repeated to maintain the fluid pumping and/or mixing action of flow/mixer device 100.

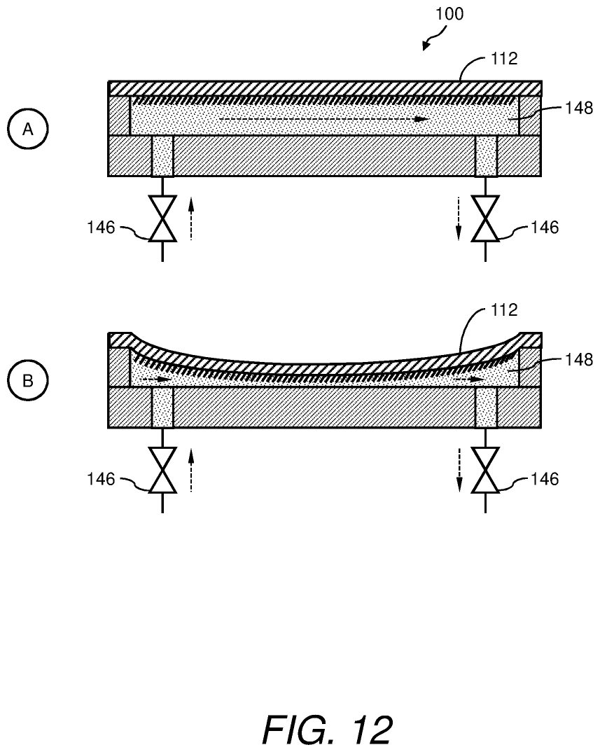

In another example, FIG. 12 shows an example of a process of using flow/mixer device 100 for fluid metering and/or mixing. Again, inlet valve 146 is provided at inlet 118 and outlet valve 146 is provided at outlet 120. This fluid metering and/or mixing process may include, but is not limited to, the following steps.

In a step A, both inlet valve 146 and outlet valve 146 are open and flexible membrane 112 is in the “neutral” (unflexed) state (see FIG. 2) under the control of membrane actuator 140 (not shown; see FIG. 2), which allows flow chamber 116 to be filled with fluid 148. This also allows fluid 148 to flow freely through flow chamber 116 from inlet 118 to outlet 120 via, for example, an external pumping force (not shown) such as an external pump. Further, in this step, using magnetic actuation mechanism 142 (not shown; see FIG. 3), the magnetically-responsive surface-attached microposts 130 may be actuated to provide mixing action or not actuated for no mixing action.

In a step B, with both inlet valve 146 and outlet valve 146 still open, membrane actuator 140 (see FIG. 2) may be used to place flexible membrane 112 in the “positive” (flexed or deflected) state (see FIG. 2) to any controlled degree, which restricts the flow of fluid 148 through flow chamber 116 from inlet 118 to outlet 120. In this way, the volume of fluid 148 flowing through flow chamber 116 may be metered (measured) or controlled by the amount of deflection of flexible membrane 112. Further, in this step, using magnetic actuation mechanism 142 (see FIG. 3), the magnetically-responsive surface-attached microposts 130 may be actuated to provide mixing action or not actuated for no mixing action.

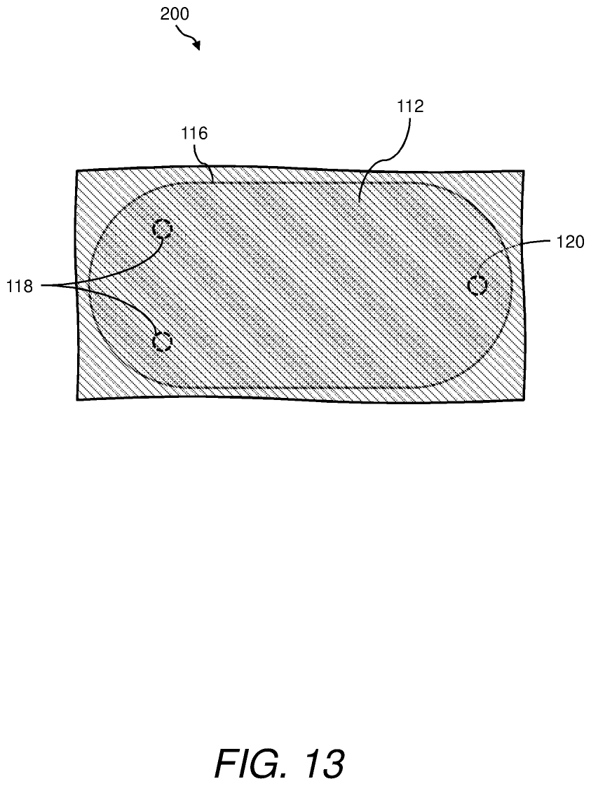

Flow chamber 116 of flow/mixer device 100 is not limited to the configurations and/or processes shown and described in FIG. 1 through FIG. 12. In another example, FIG. 13 shows a top view of a flow/mixer device 200 that includes two inlets 118 and one outlet 120. Additionally, valves 146 (not shown) may be provided with respect to inlets 118 and outlet 120. In flow/mixer device 200, both pumping and mixing operations may occur. For example, one inlet 118 may be supplied by some kind of reagent or sample fluid while the other inlet 118 may be supplied by a wash buffer solution. Accordingly, in a chamber filling step, flexible membrane 112 may be used to pump reagent or sample fluid into flow chamber 116. Then in a mixing step, the magnetically-responsive surface-attached microposts 130 (not shown) may be actuated to provide mixing in flow chamber 116 to enhance and/or hasten any reactions that may be taking place. Then in a wash step, flexible membrane 112 may be used to pump wash buffer solution into flow chamber 116 and to flush out the processed fluid.

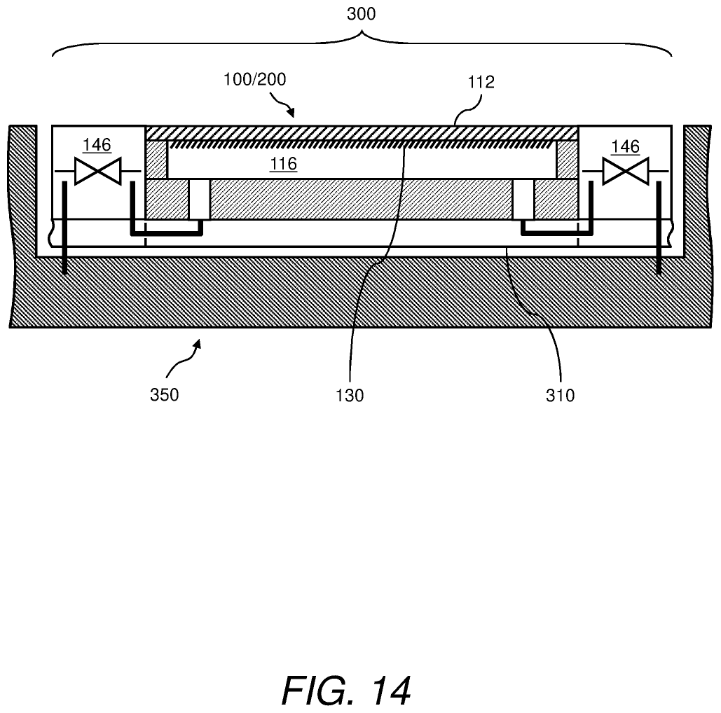

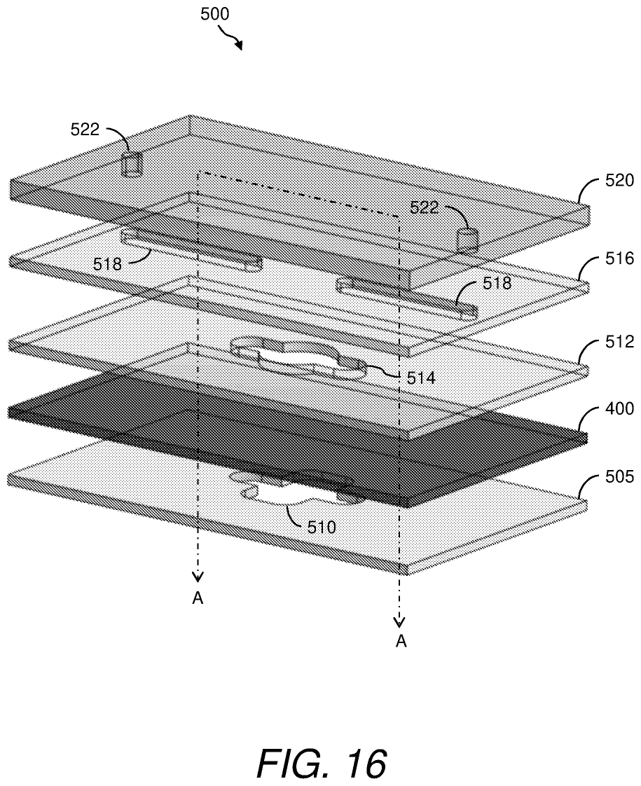

FIG. 14 illustrates a side view of an example of an integrated structure or microfluidics system 300 including a magnetically-responsive element such as, e.g., the presently disclosed flow/mixer device 100/200 including flexible membrane 112 and magnetically-responsive surface-attached microposts 130. In one embodiment, the microfluidics system may include: a magnetically-responsive element comprising fluid input and fluid output ports or valves; a microfluidics cartridge 350 comprising fluid input and fluid output channels for fluidly connecting to the fluid input and fluid output ports or valves of the magnetically-responsive element; a controller (not shown) for controlling the operation of the magnetically-responsive element and the microfluidics cartridge; and wherein the magnetically-responsive element is sized to engagingly fit within the microfluidics cartridge. In other embodiments, the magnetically-responsive element may be selected from a group consisting of a magnetic-based pinch valve, a magnetic-based peristaltic pump, a magnetic-based mixer, a magnetic-based reciprocal pump, and a flow-metering device, as described hereinbelow with reference to FIG. 16 through FIG. 39.

The microfluidics system 300 may include any type and/or configuration of magnetically-responsive element, e.g., flow/mixer devices 100/200, with or without a routing layer 310 for coupling fluidly to any other components, devices, and/or structures, such as, but not limited to, valves 146. FIG. 14 also shows a magnetically-responsive element being sized to engagingly fit (or be installed in) a larger structure and/or system, such as microfluidics cartridge 350.

Further, a large-scale manufacturing environment may be used for mass producing the microfluidics system 300. For example, wafer-level manufacturing processes may be used to form microfluidics system 300 that are then diced and shipped. In one example, microfluidics system 300 may be formed according to the processes described with reference to the U.S. Patent App. No. 62/522,536, entitled “Modular Active Surface Devices for Microfluidic Systems and Methods of Making Same,” filed on Jun. 20, 2017, the entire disclosure of which is incorporated herein by reference.

The '536 patent application describes a modular active surface device that includes an active surface layer mounted atop an active surface substrate, a mask mounted atop the active surface layer wherein the mask defines the area, height, and volume of the reaction chamber, and a substrate mounted atop the mask wherein the substrate provides the facing surface to the active surface layer. Further, the modular active surface device can include other layers, such as, but not limited to, adhesive layers, stiffening layers for facilitating handling, and peel-off sealing layers. Further, the '536 patent application describes a large-scale manufacturing method of mass producing the modular active surface devices. The integrated structure 300 may be an example of the modular active surface devices described in the '536 patent application. Further, in flow/mixer device 100/200 and/or integrated structure 300, flexible membrane 112 including magnetically responsive surface-attached microposts 130 may be an example of the active surface layer described in the '536 patent application.

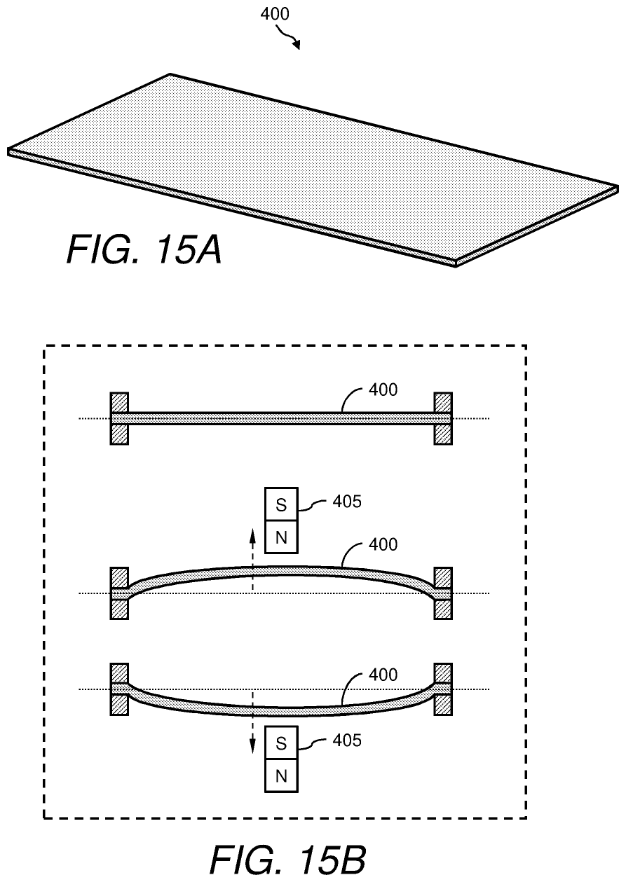

FIG. 15A and FIG. 15B is a perspective view and side views, respectively, of an example of a magnetically-responsive flexible membrane 400. Magnetically-responsive flexible membrane 400 may be used to form other examples of the presently disclosed microfluidic devices and methods including flexible membranes and/or magnetically-responsive elements. More details of examples of microfluidic devices and methods including flexible membranes and/or magnetically-responsive elements that utilize magnetically-responsive flexible membrane 400 are described hereinbelow with reference to FIG. 16 through FIG. 38.

Magnetically-responsive flexible membrane 400 may be formed of a flexible material doped with a magnetically-responsive material. The flexible material may be, for example, silicone, or any elastomeric materials, such as a hydrogel and polydimethylsiloxane (PDMS), or any low modulus, thermoplastic elastomers or fluoropolymer. Examples of magnetically-responsive material in magnetically-responsive flexible membrane 400 include iron (Fe), nickel (Ni), cobalt (Co), as well as metal oxides, such as, but not limited to, ferroferric oxide (Fe₃O₄), barium hexaferrite (BaFe₁₂O₁₉), cobalt(II) oxide (CoO), nickel(II) oxide (NiO), manganese(III) oxide (Mn₂O₃), chromium(III) oxide (Cr₂O₃), and cobalt manganese phosphide (CoMnP).

Further, in magnetically-responsive flexible membrane 400, the amount of flexible material may be, for example, from about 40% to about 90% by weight, while the amount of magnetically responsive material may be, for example, from about 10% to about 60% by weight. In one example, magnetically-responsive flexible membrane 400 may be a silicone/iron membrane. In this example, the amount of silicone may be, for example, from about 40% to about 45% by weight, while the amount of iron may be, for example, from about 55% to about 60% by weight. Additionally, the thickness of magnetically-responsive flexible membrane 400 can vary, for example, from about 100 μm to about 1,000 μm.

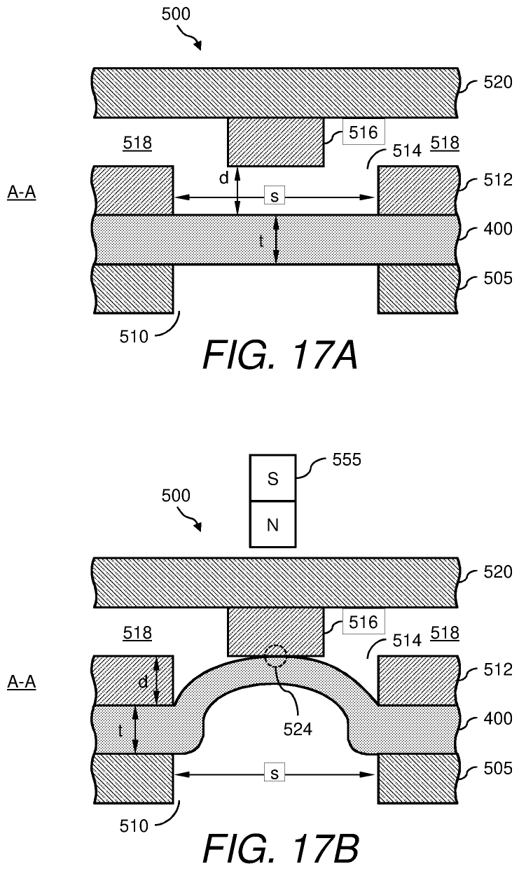

FIG. 15B shows an example of the operation of magnetically-responsive flexible membrane 400. First, a span or area of magnetically-responsive flexible membrane 400 is held secure in free space in the absence of a magnetic force. Next, a magnet 405 provides a magnetic force above magnetically-responsive flexible membrane 400. Accordingly, magnetically-responsive flexible membrane 400 is attracted to magnet 405 and deflects upward toward magnet 405. Next, magnet 405 provides a magnetic force below magnetically-responsive flexible membrane 400. Accordingly, magnetically-responsive flexible membrane 400 is attracted to magnet 405 and deflects downward toward magnet 405. More details of the design parameters for using magnetically-responsive flexible membrane 400 are shown and described hereinbelow with reference to FIG. 17A and FIG. 17B.

FIG. 16 is an exploded view of an example of a magnetics-based (magnetically-responsive) pinch valve 500 that includes a magnetically-responsive flexible membrane 400. Magnetically-responsive pinch valve 500 is another example of the presently disclosed microfluidic devices and methods including flexible membranes and/or magnetically-responsive elements. Magnetically-responsive pinch valve 500 may include, for example, a bottom substrate 505 with a top surface and a bottom surface that has an opening 510 therethrough, a layer of magnetically-responsive flexible membrane 400 with a top surface and a bottom surface, a pinch valve layer 512 with a top surface and a bottom surface that has a pinch valve chamber 514, a routing layer 516 with a top surface and a bottom surface that includes channels 518, and a top substrate 520 with a top surface and a bottom surface that includes at least two fluid ports 522. In one example, bottom substrate 505 may be a plastic or glass substrate that may be from about 1,000 μm to about 4,000 μm thick. Further, pinch valve layer 512 and top substrate 520 may be formed, for example, of plastic or glass and each may be from about 500 μm to about 3,000 μm thick.

The opening 510 in bottom substrate 505 is sized to substantially align with pinch valve chamber 514 of pinch valve layer 512 such that a portion of magnetically-responsive flexible membrane 400 is held suspended in free space. The characteristics of magnetically-responsive flexible membrane 400 (e.g., thickness, percent doping of its magnetically responsive material) may vary depending on the physical design of magnetically-responsive pinch valve 500. For example, FIG. 17A and FIG. 17B is cross-sectional views of a portion of magnetically-responsive pinch valve 500 shown in FIG. 16 in a non-actuated (neutral or flat) and actuated (positive or deflected or flexed) state, respectively. The cross-sectional views are taken along line A-A of FIG. 16.

For example, with respect to magnetically-responsive flexible membrane 400 in magnetically-responsive pinch valve 500 there is a span (s) and a deflection distance (d). Further, magnetically-responsive flexible membrane 400 has a thickness (t) and a magnetic loading (L). The magnetic loading (L) is expressed, for example, as percent (%) of magnetic material by weight. The maximum deflection distance (d) of magnetically-responsive flexible membrane 400 may be determined by, for example, the material stiffness as a function of thickness (t), the amount of magnetic loading (L), and the properties of the magnetic field. Generally, when using magnetically-responsive flexible membrane 400, there may be a span-to-deflection distance ratio (s:d ratio). Examples of magnetically-responsive flexible membrane 400 for certain design parameters are shown below in Table 1 and Table 2.

TABLE 1
Example design parameters for magnetically
responsive flexible membrane 400

| Flexible Material type | Silicone |
|---|---|
| % Flexible Material | about 80% to about 90% by weight |
| Magnetically Responsive Material | Iron (Fe) |
| type | |
| % Magnetically Responsive Material | about 10% to about 20% by weight |
| Thickness (t) | about 100 μm to about 150 μm |
| Span (s) | about 6000 μm to about 6500 μm |
| Deflection distance (d) | about 300 μm to about 350 μm |
| Span-to-Deflection Distance Ratio | 17:1 to 22:1 |
| (s:d Ratio) | |

TABLE 2
Example design parameters for magnetically
responsive flexible membrane 400

| Flexible Material type | Silicone |
|---|---|
| % Flexible Material | about 40% to about 50% by weight |
| Magnetically Responsive Material | Iron (Fe) |
| type | |
| % Magnetically Responsive Material | about 50% to about 60% by weight |
| Thickness (t) | about 100 μm to about 150 μm |
| Span (s) | about 3000 μm to about 3500 μm |
| Deflection distance (d) | about 300 μm to about 350 μm |
| Span-to-Deflection Distance Ratio | 9:1 to 12:1 |
| (s:d Ratio) | |

Referring now again to Table 1 and Table 2, in magnetically-responsive flexible membrane 400 less doping corresponds to a larger s:d ratio to achieve acceptable valve pinching. Conversely, more doping means that the flexible membrane deflects more under a given magnetic field and therefore the valve can pinch with a smaller s:d ratio. For example, Table 1 shows an example of about 10% to about 20% magnetically-responsive material may result in an s:d ratio of from about 17.1 to 22.1. By contrast, Table 2 shows a higher 50% to about 60% magnetically-responsive material may result in the lower s:d ratio of from about 9.1 to 12.1.

In one example, the span (s) and deflection distance (d) (or s:d ratio) are set and then the characteristics of magnetically-responsive flexible membrane 400 are tailored to the pre-defined span (s) and deflection distance (d). In another example, the characteristics of magnetically-responsive flexible membrane 400 are set and then the span (s) and deflection distance (d) are tailored to the pre-defined magnetically-responsive flexible membrane 400. Another control parameter is the strength of the magnetic force used with magnetically-responsive flexible membrane 400.

FIG. 17A shows magnetically-responsive flexible membrane 400 in a relaxed state in the absence of any magnetic force. By contrast, FIG. 17B shows magnetically-responsive flexible membrane 400 in a deflected state in the presence of a means for providing a magnetic force that is arranged relative to the magnetically-responsive flexible membrane such that application of magnetic force, e.g., via a magnet 555, to the magnetically-responsive flexible membrane 400 causes the membrane to deflect upward to contact a corresponding surface point 524 (i.e., a seal point, line, and/or area) on the routing layer 516. That is, magnetically-responsive flexible membrane 400 is attracted to magnet 555 and therefore deflects toward magnet 555. The attraction of magnetically-responsive flexible membrane 400 to magnet 555 is due to the magnetically-responsive material in magnetically-responsive flexible membrane 400. In this example, the thickness of pinch valve layer 512 defines the deflection distance (d). Further, features of routing layer 516 provide a “stop” or “surface or contact point” for the deflected magnetically-responsive flexible membrane 400. The localized magnetic force of magnet 555 forms a seal point, line, and/or area 524 against routing layer 516.

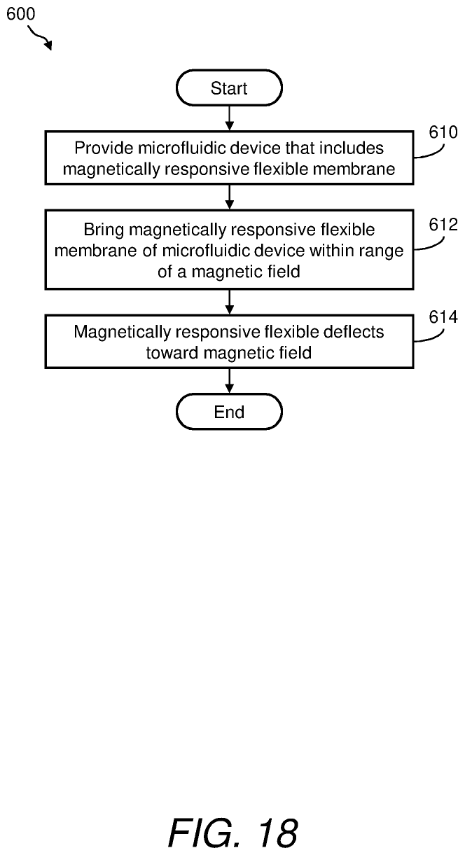

FIG. 18 is a flow diagram of a method 600, which is an example of a method of operation of magnetically-responsive flexible membrane 400 in a microfluidic device, such as, but not limited to, magnetically-responsive pinch valve 500. Method 600 may include, but is not limited to, the following steps.

At a step 610, a microfluidic device is provided that includes magnetically-responsive flexible membrane 400. In one example, the magnetically-responsive pinch valve 500 shown in FIG. 16, FIG. 17A and FIG. 17B is provided that includes magnetically-responsive flexible membrane 400. In magnetically-responsive pinch valve 500, magnetically-responsive flexible membrane 400 is provided across a certain span (s) and has an expected deflection distance (d). Absent any magnetic force, magnetically-responsive flexible membrane 400 is in a relaxed (or neutral) state as shown in FIG. 17A.

At a step 612, magnetically-responsive flexible membrane 400 of the microfluidic device is brought within range of a magnetic field. As illustrated in FIG. 17B, a magnet 555 is brought in close proximity to magnetically-responsive flexible membrane 400 of magnetically-responsive pinch valve 500. As a result, magnetically-responsive flexible membrane 400 is within range of the magnetic field of magnet 555.

At a step 614, magnetically-responsive flexible membrane 400 of the microfluidic device deflects toward the magnetic field. FIG. 17B shows magnetically-responsive flexible membrane 400 of magnetically-responsive pinch valve 500 is attracted to magnet 555 and therefore deflects toward magnet 555. The attraction of magnetically-responsive flexible membrane 400 to magnet 555 is due to the magnetically-responsive material (e.g., iron (Fe), nickel (Ni), cobalt (Co)) in magnetically-responsive flexible membrane 400.

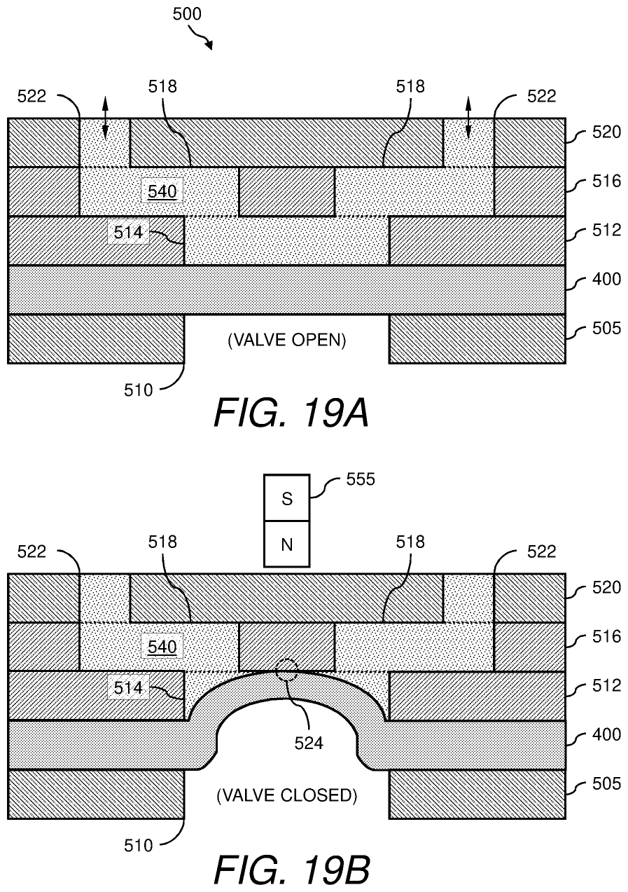

FIG. 19A and FIG. 19B illustrate side views of magnetically-responsive pinch valve 500 shown in FIG. 16 in the open and closed states, respectively. The operations of magnetically-responsive pinch valve 500 are based on the steps of method 600 of FIG. 18. A flow channel or path is formed between the two fluid ports 522. For example, the space inside pinch valve chamber 514 of pinch valve layer 512 is fluidly connected to the two fluid ports 522 via channels 518 in routing layer 516. In one example, the flow channel is filled with fluid 540.

FIG. 19A shows magnetically-responsive flexible membrane 400 in a relaxed (neutral or non-deflected) state because of the absence of any magnetic force. Accordingly, FIG. 19A shows fluid 540 sitting above magnetically-responsive flexible membrane 400 in pinch valve chamber 514 of pinch valve layer 512 and air sitting below magnetically-responsive flexible membrane 400 in opening 510 of bottom substrate 505. That is, FIG. 19A shows magnetically-responsive pinch valve 500 in the “open” state in which fluid 540 may flow freely between the two fluid ports 522.

By contrast, FIG. 19B shows magnetically-responsive flexible membrane 400 in the presence of a means for providing a magnetic force, e.g., a magnet 555. This causes magnetically-responsive flexible membrane 400 to deflect toward magnet 555 and provide a tangential seal (e.g., a seal point, line, and/or area 524) against a portion of routing layer 516 that is between the two channels 518. That is, FIG. 19B shows magnetically-responsive pinch valve 500 in the “closed” state in which fluid 540 is blocked from flowing freely between the two fluid ports 522.

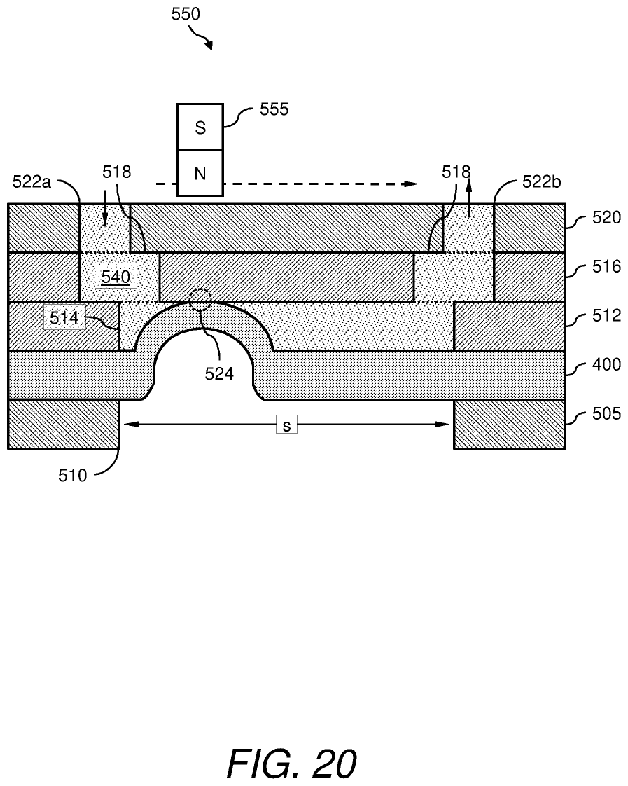

FIG. 20 through FIG. 23 illustrate cross-sectional side views of an example of a magnetics-based (i.e., magnetically-responsive) peristaltic pump 550 including magnetically-responsive flexible membrane 400. Magnetically-responsive peristaltic pump 550 is another example of the presently disclosed microfluidic devices and methods including flexible membranes and/or magnetically-responsive elements. Magnetically-responsive peristaltic pump 550 provides substantially the same structure as magnetically-responsive pinch valve 500 shown in FIG. 16, FIG. 19A, and FIG. 19B except that the span (s+) (not shown) of magnetically-responsive flexible membrane 400 across opening 510 in bottom substrate 505 and pinch valve chamber 514 of pinch valve layer 512 has been extended (hence, (s+)). Accordingly, the distance or space (i.e., span) between the two channels 518 in routing layer 516 has also been extended.

Further, a means for providing a magnetic force, i.e., a magnet 555, provides a small localized magnetic force as compared with the full span (s+) of magnetically-responsive flexible membrane 400. Accordingly, the magnetic force of magnet 555 intersects a small portion only of the span (s+) and of magnetically-responsive flexible membrane 400. For example, FIG. 20 shows a means for providing a moving magnetic force, i.e., a moving magnet 555, that is arranged relative to the magnetically-responsive membrane 400 such that application of the moving magnetic force to the magnetically-responsive flexible membrane 400 causes the magnetically-responsive flexible membrane 400 to contact a corresponding surface point on the routing layer 516 to form a seal point 524 and slidingly move along an x-y axial path of the (s+) span of free space and along a corresponding x-y axial path of a span (s) of the routing layer 516. Further, magnet 555 may be placed in close proximity to magnetically-responsive peristaltic pump 550 and positioned substantially toward one of the two fluid ports 522, such as toward fluid port 522a. Accordingly, the localized magnetic force of magnet 555 forms a seal point, line, and/or area 524 near fluid port 522a. FIG. 20 shows some volume of fluid 540 on both sides of seal point, line, and/or area 524 of magnetically-responsive flexible membrane 400.

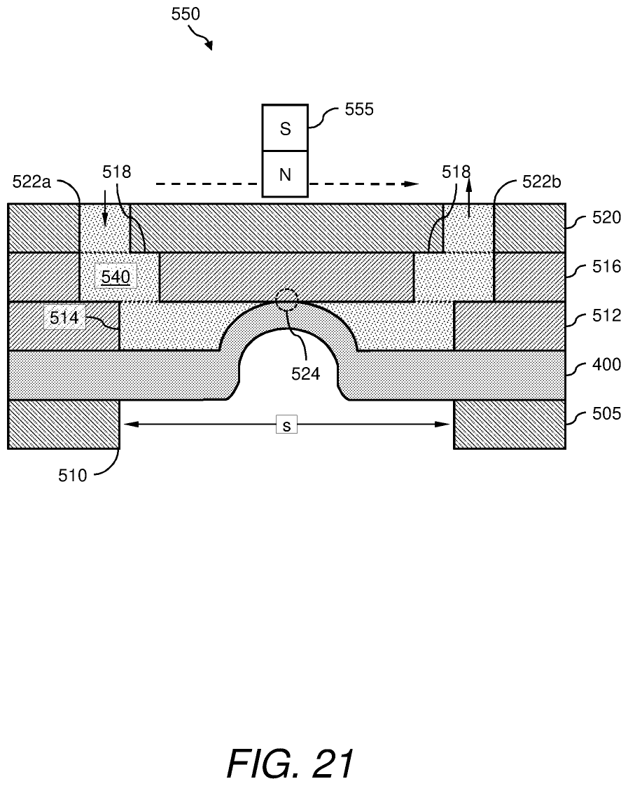

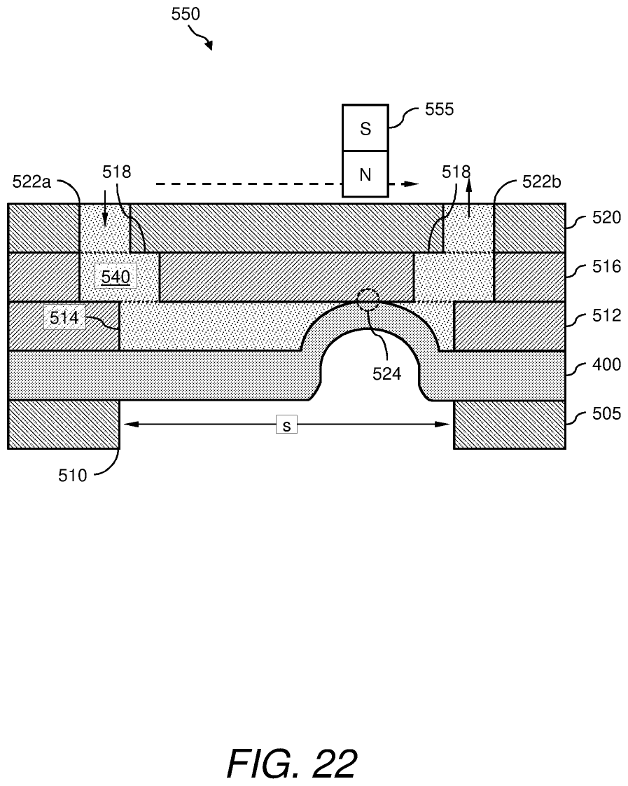

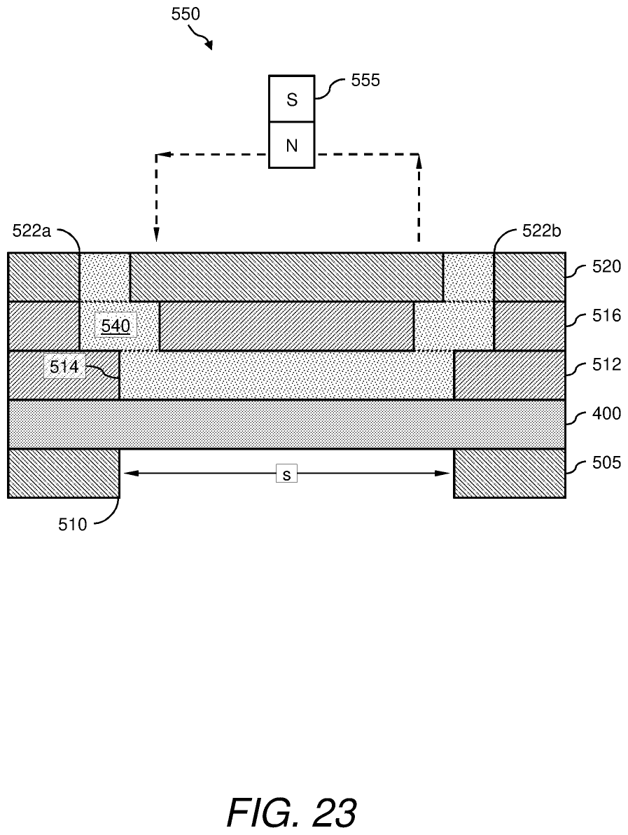

FIG. 21 and FIG. 22 illustrate magnet 555 slidingly moved or translated across span (s+) of magnetically-responsive flexible membrane 400 (e.g., away from fluid port 522a and toward fluid port 522b). In so doing, seal point, line, and/or area 524 of magnetically-responsive flexible membrane 400 also “moves” (“slides” or “travels”) across the surface of routing layer 516 in an x-y axial plane. As seal point, line, and/or area 524 moves or slides across routing layer 516, fluid 540 in advance of the moving seal point, line, and/or area 524 pushes out of magnetically-responsive peristaltic pump 550 while fluid 540 trailing the moving seal point, line, and/or area 524 is drawn into magnetically-responsive peristaltic pump 550. Upon completion of the cycle, magnet 555 may be distanced from magnetically-responsive peristaltic pump 550 and cycled back to near fluid port 522a, as shown in FIG. 23. Next, the operations shown in FIG. 20 through FIG. 23 may be sequentially repeated to continue the peristaltic pumping action of magnetically-responsive peristaltic pump 550. The operations of magnetically-responsive peristaltic pump 550 are generally based on the steps of method 600 of FIG. 18.

FIG. 19A through FIG. 23 show the seal point, line, and/or area 524 is a seal line 524 that forms at the ceiling (top) of the chamber. This seal line 524 may be formed by providing a certain orientation of magnetic field lines from magnet 555 with respect to the chamber.

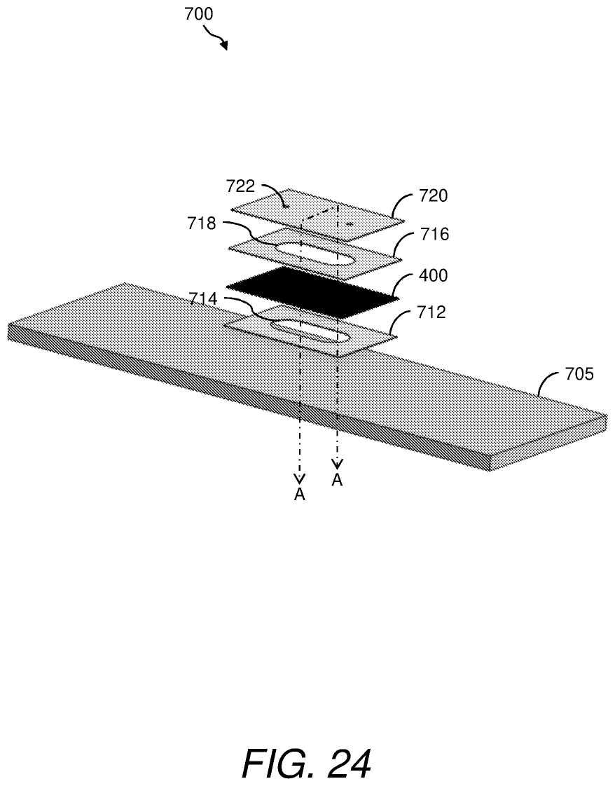

FIG. 24 is an exploded view of an example of a magnetics-based (magnetically-responsive) single-chamber mixer 700 that includes a magnetically-responsive flexible membrane 400. Magnetically-responsive single-chamber mixer 700 is another example of the presently disclosed microfluidic devices and methods including flexible membranes and/or magnetically-responsive elements. Magnetically-responsive single-chamber mixer 700 may include, for example, a bottom substrate 705 with a top surface and a bottom surface, a layer of magnetically-responsive flexible membrane 400 with a top surface and a bottom surface, a first mask layer 712 with a top surface and a bottom surface that has an opening 714, a second mask layer 716 with a top surface and a bottom surface that includes a reaction chamber 718, and a top substrate 720 with a top surface and a bottom surface that includes at least two fluid ports 722. In one example, bottom substrate 705 may be a plastic or glass substrate that may be from about 1,000 μm to about 4,000 μm thick. Further, first mask layer 712 and second mask layer 716 may be formed, for example, of plastic or glass and each may be from about 200 μm to about 800 μm thick. The opening 714 in mask layer 712 substantially aligns with reaction chamber 718 of mask layer 716 such that a portion of magnetically-responsive flexible membrane 400 may be held suspended in free space.

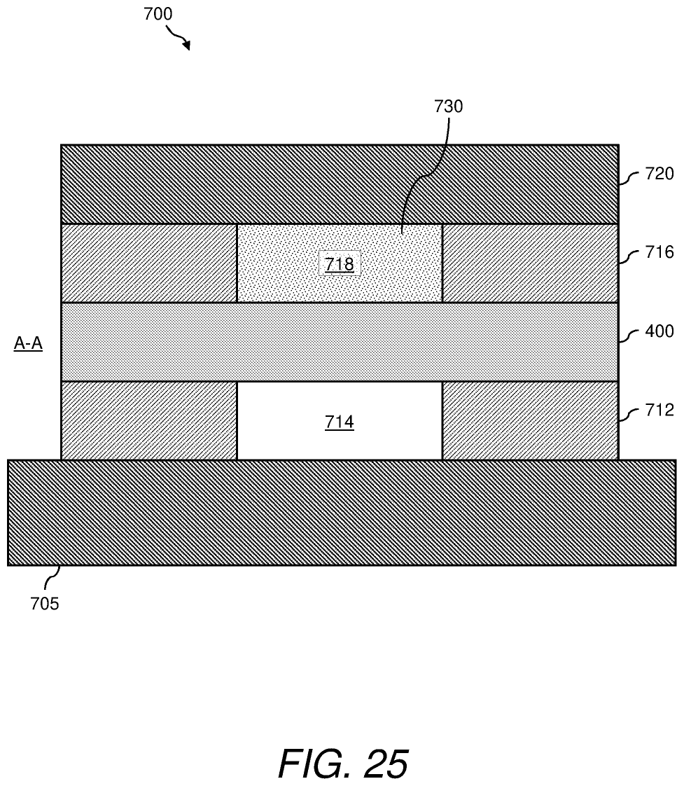

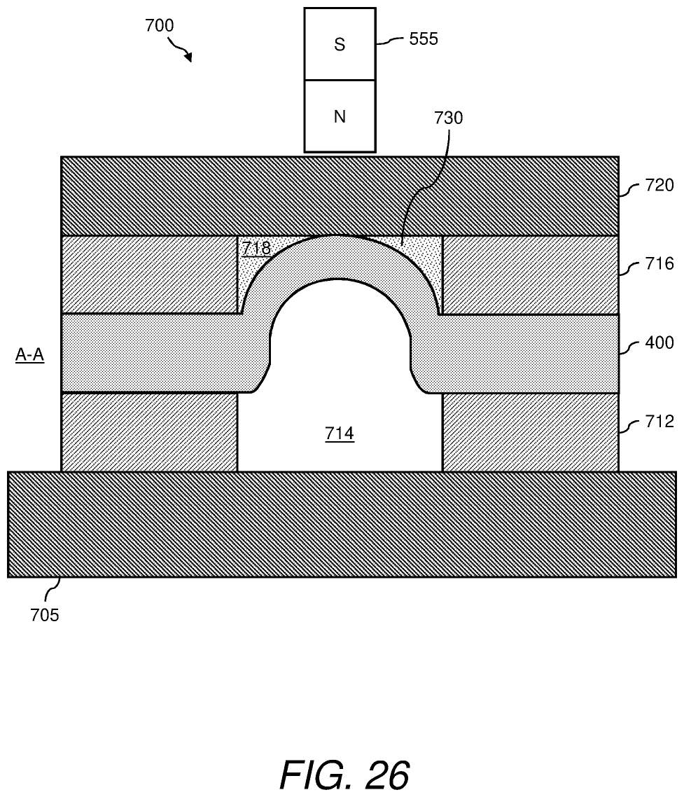

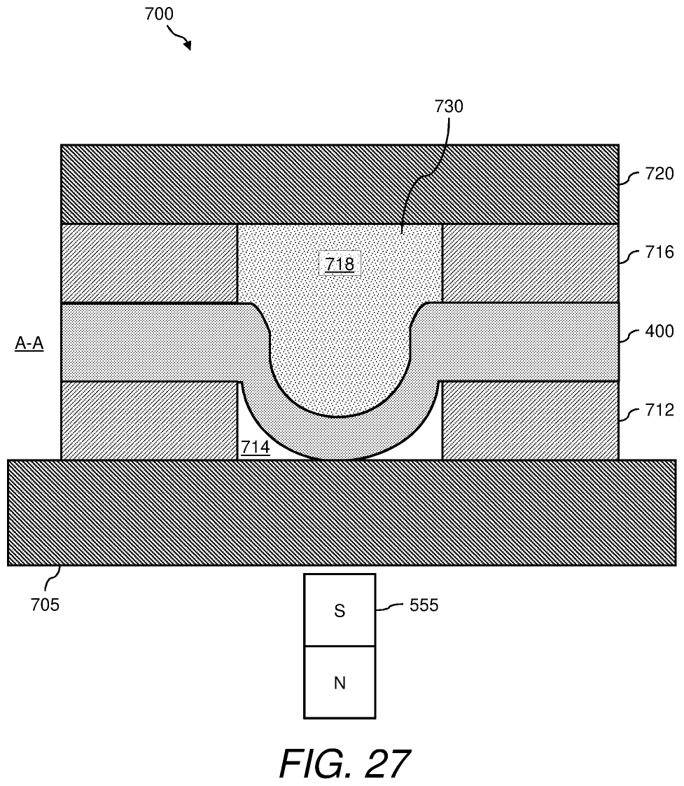

FIG. 25, FIG. 26, and FIG. 27 are side views (taken along line A-A of FIG. 24) showing an example of a process of using the magnetically-responsive single-chamber mixer 700 shown in FIG. 24. The operations of magnetically-responsive single-chamber mixer 700 are generally based on the steps of method 600 of FIG. 18. FIG. 25 shows a fluid 730 in reaction chamber 718. Fluid 730 may be any fluid to be processed in magnetically-responsive single-chamber mixer 700. FIG. 25 also shows magnetically-responsive flexible membrane 400 in a relaxed state in the absence of any magnetic force.

FIG. 26 shows a first means for providing a magnetic force to the magnetically-responsive flexible membrane 400 which is arranged relative to a free space of span (s) such that applying a first magnetic force to the free space of span (s) causes the magnetically-responsive flexible membrane 400 to deflect upwards to contact a corresponding surface point on the bottom surface of the top substrate 720, thereby forming a seal to prevent the flow of fluid into (or through) reaction chamber 718, e.g., a top magnet 555, which may be placed in close proximity to top substrate 720. As such, magnetically-responsive flexible membrane 400 deflects toward top substrate 720, which is toward top magnet 555.

FIG. 27 shows a second means for providing a magnetic force to the magnetically-responsive flexible membrane 400, wherein the second means for providing a magnetic force is arranged relative to the free space of span (s) such that applying a second magnetic force to the free space of span (s) to cause the magnetically-responsive flexible membrane 400 to deflect downwards to contact a corresponding surface point on the top surface of bottom substrate 705, thereby forming a seal to allow the flow of fluid into (or through) the reaction chamber, e.g., a bottom magnet 555, which may be placed in close proximity to bottom substrate 705. As such, magnetically-responsive flexible membrane 400 deflects (downward) toward bottom substrate 705, which is toward bottom magnet 555.

In magnetically-responsive single-chamber mixer 700 shown in FIG. 24, FIG. 25, FIG. 26, and FIG. 27 certain fluid channels and/or spaces (not shown) are provided that allow fluid 730 to flow freely in and out of reaction chamber 718 during the operation thereof.

Accordingly, magnetically-responsive single-chamber mixer 700 operates by alternating the presence of magnetic force from a first means for providing a magnetic force and a second means for providing a magnetic force, e.g., a top magnet 555 and a bottom magnet 555, which alternates the deflection of magnetically-responsive flexible membrane 400. The alternating deflection of magnetically-responsive flexible membrane 400 provides mixing action within reaction chamber 718 of magnetically-responsive single-chamber mixer 700. Essentially, the top magnet 555 and the bottom magnet 555 may be controlled to provide a pulsing or beating action of magnetically-responsive flexible membrane 400 at a selected frequency.

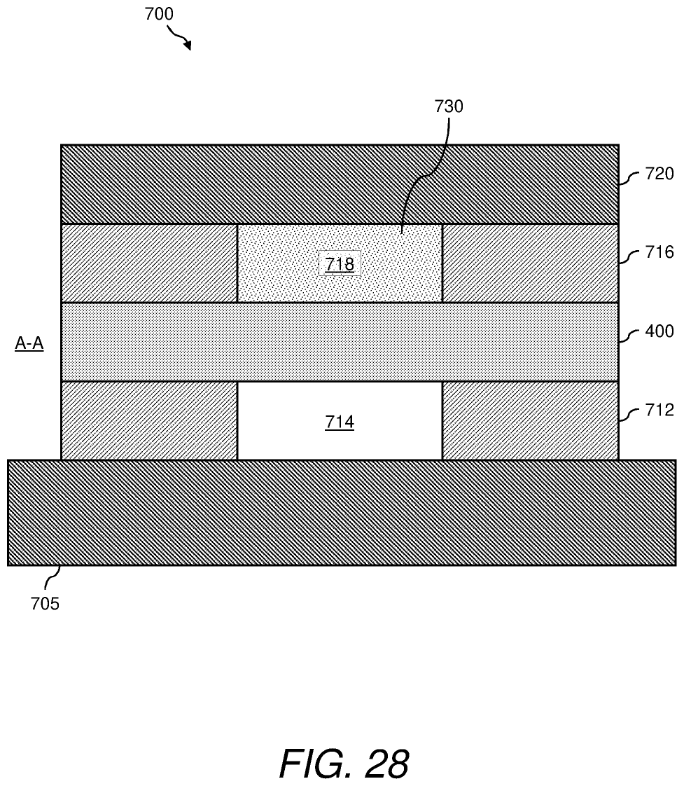

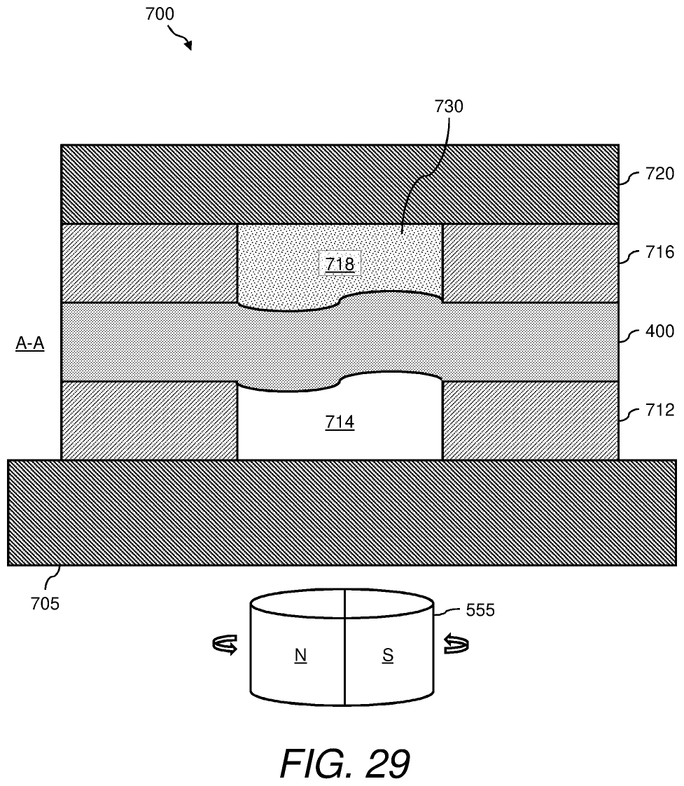

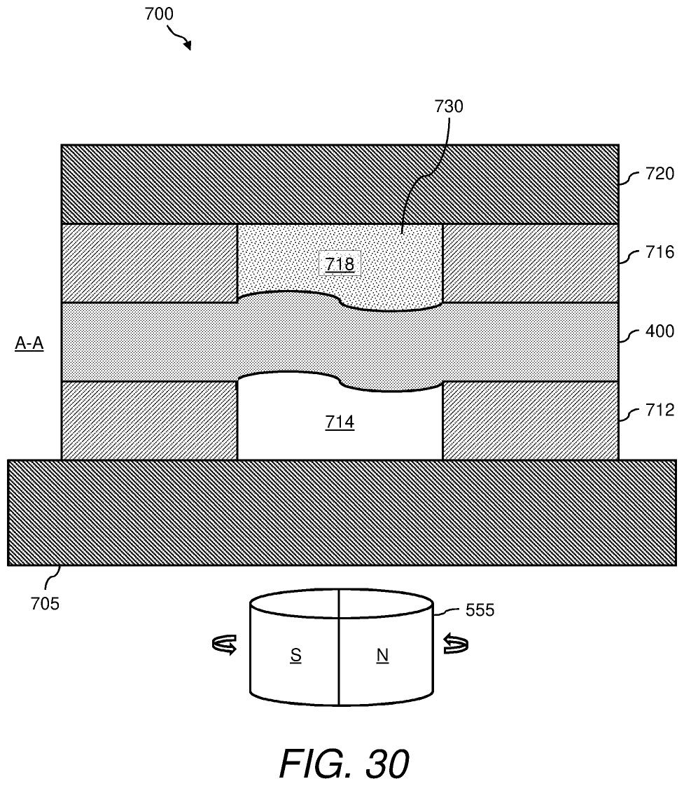

FIG. 28, FIG. 29, and FIG. 30 are side views showing an example of another process of using the magnetically-responsive single-chamber mixer 700 shown in FIG. 24. Again, the operations of magnetically-responsive single-chamber mixer 700 are based on the steps of method 600 of FIG. 18. In this example, instead of alternating a magnet from one side to the other (i.e., from top to bottom), a rotating magnetic force means is provided wherein rotation of the rotating magnetic force means, e.g., a rotating magnet 555, is arranged relative to the magnetically-responsive flexible membrane 400 such that rotating the magnetic force means around an axis of rotation causes magnetic force to be applied or not applied to the magnetically-responsive flexible membrane 400, wherein the magnetically-responsive flexible membrane 400 is caused to alternate between states of deflection and non-deflection and to correspondingly move along an x-y axial path within the free space of span (s) (span (s) is not shown in FIGS.), thereby causing a fluid seal formed by the magnetically-responsive flexible membrane 400 contacting a corresponding surface of the first and second mask layers upon deflection of the membrane to also slidingly move along an x-y axial path of span (s) of the mask layers within the free space of span (s) in synchrony with the movement of the magnetically-responsive flexible membrane 400, thereby causing fluid mixing in reaction chamber 718. Further, rotating magnet 555 may be placed in close proximity to either side of the magnetically-responsive single-chamber mixer 700.

For example, FIG. 28 shows magnetically-responsive flexible membrane 400 in a relaxed state in the absence of any magnetic force. Next, FIG. 29 and FIG. 30 show a rotating magnet 555 rotating around an axis in close proximity to bottom substrate 705 (or top substrate 720). The changing and/or rotating polarity provided by the rotating magnetic force means causes a corresponding ripple (or wave-like) motion in magnetically-responsive flexible membrane 400 with respect to the plane of its relaxed state. The ripple (or wave-like) motion of magnetically-responsive flexible membrane 400 provides mixing action within reaction chamber 718 of magnetically-responsive single-chamber mixer 700. In this example, the mixing action may be controlled, for example, via the magnetic field strength of the rotating magnetic force and the rotations per minute (RPM) of the rotating magnetic force.

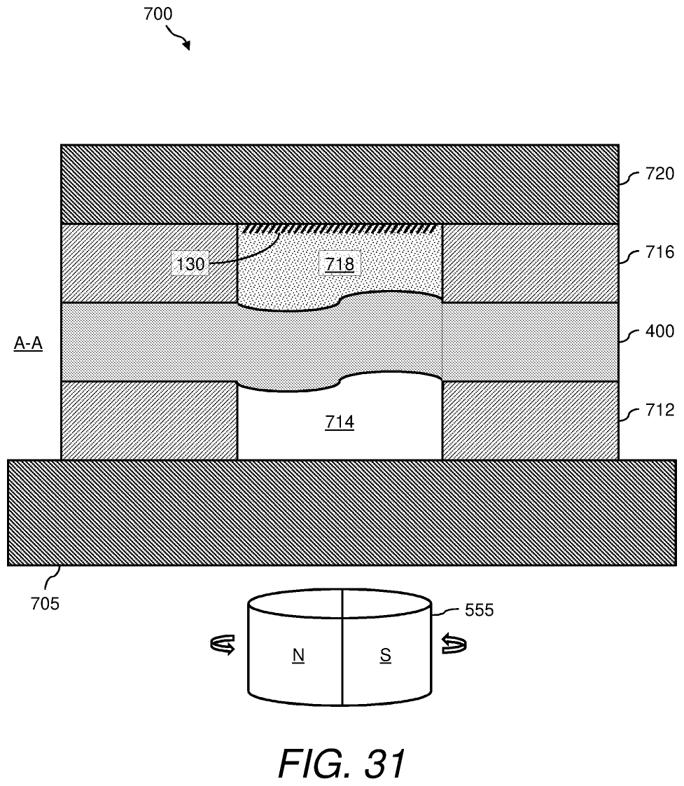

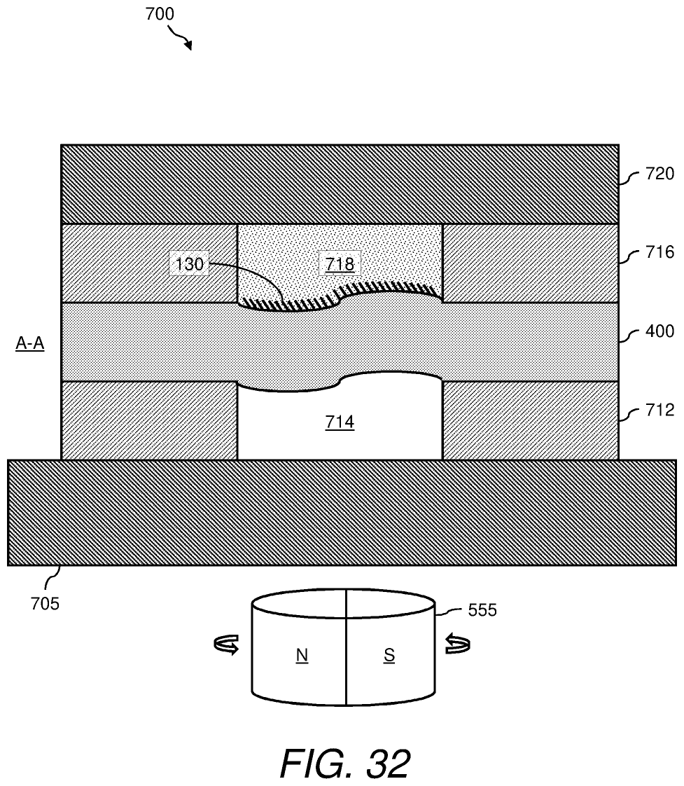

FIG. 31 through FIG. 34 illustrate cross-sectional side views of the magnetic-based (magnetically responsive) single-chamber mixer 700 shown in FIG. 24 through FIG. 30 and including other useful features. For example, FIG. 31 shows magnetically-responsive single-chamber mixer 700 including a field or array of magnetically-responsive surface-attached microposts 130 on top substrate 720. FIG. 32 shows magnetically-responsive single-chamber mixer 700 including a field or array of magnetically-responsive surface-attached microposts 130 on magnetically-responsive flexible membrane 400.

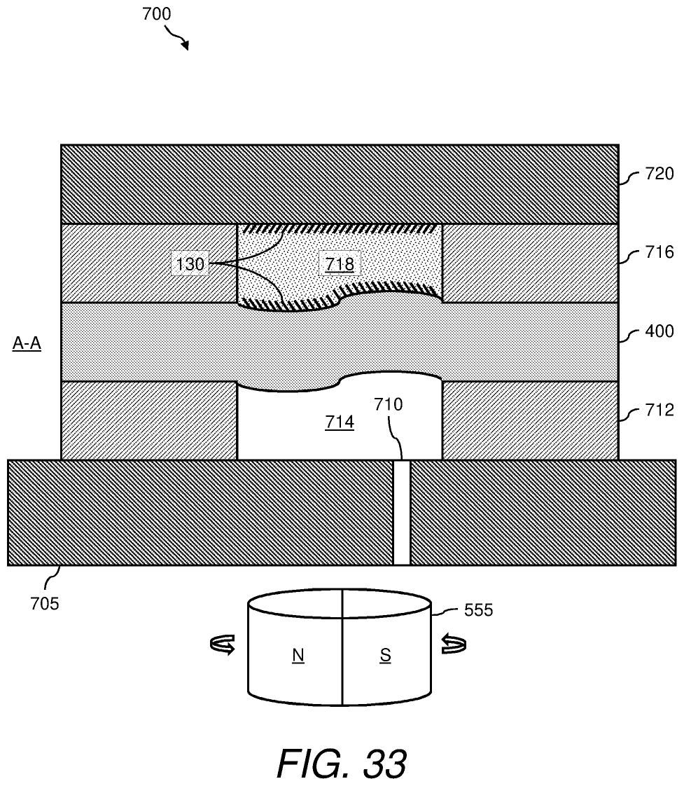

FIG. 33 shows magnetically-responsive single-chamber mixer 700 including a field or array of magnetically-responsive surface-attached microposts 130 on both top substrate 720 and magnetically-responsive flexible membrane 400. In these examples, the magnetically-responsive surface-attached microposts 130 may be actuated using, for example, the same magnetic force that is controlling magnetically-responsive flexible membrane 400 or via a separate means for providing a magnetic force. Optionally, a vent 710 may be provided in bottom substrate 705 at opening 714 in mask layer 712. Vent 710 may be provided to help manage the air pressure in opening 714 in mask layer 712, wherein the air pressure in opening 714 may change (i.e., no pressure, positive pressure, negative pressure) with the motion of magnetically-responsive flexible membrane 400.

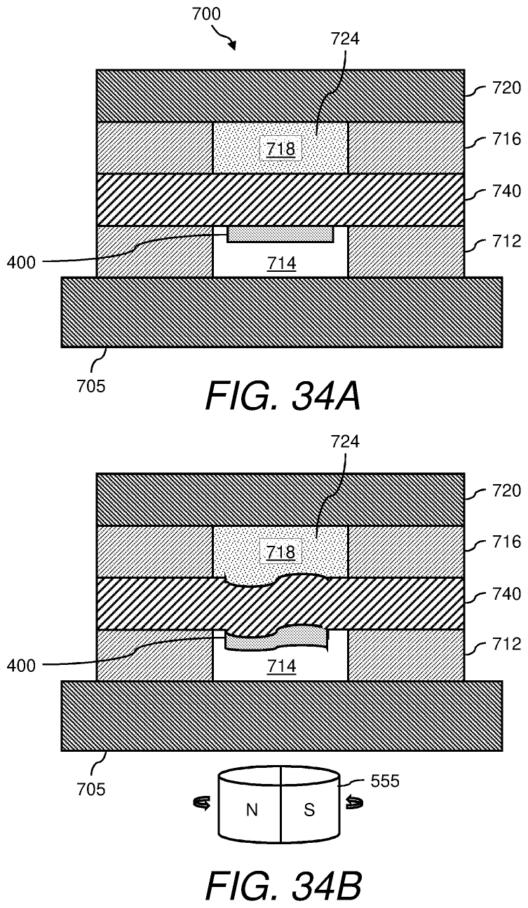

In another example, FIG. 34A and FIG. 34B shows a magnetics-based (magnetically-responsive) single-chamber mixer 700 in which the layer of magnetically-responsive flexible membrane 400 is replaced with a flexible layer 740 (e.g., a PDMS layer 740) with a top surface and a bottom surface. Then, a small segment of magnetically-responsive flexible membrane 400 is bonded to the underside of flexible layer 740 in opening 714 in mask layer 712, as shown in FIG. 34A. The small segment of magnetically-responsive flexible membrane 400 responds to the magnetic field to agitate and/or move flexible layer 740 in a manner that substantially mimics the action of a full layer of magnetically-responsive flexible membrane 400 in magnetically-responsive single-chamber mixer 700, as shown in FIG. 34B.

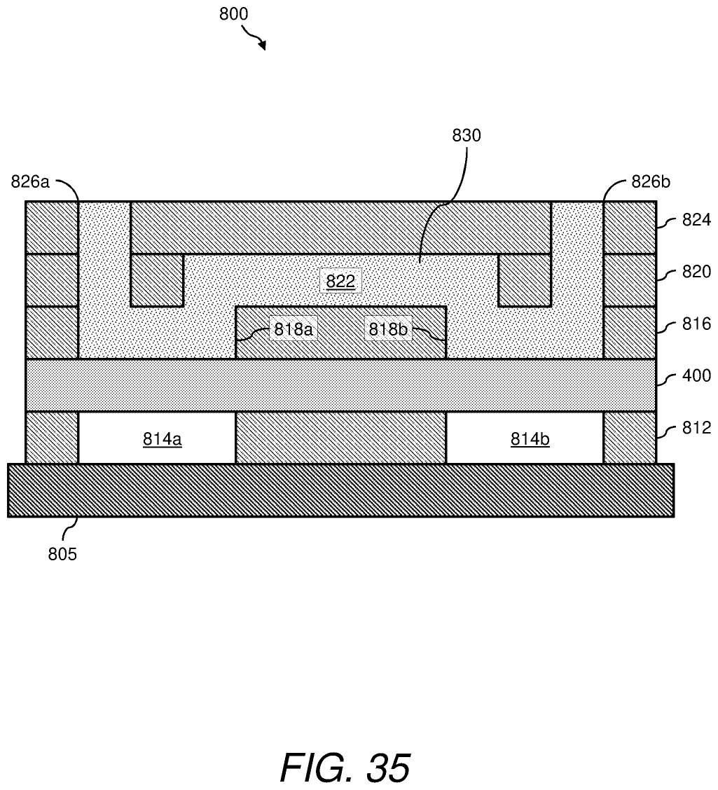

FIG. 35 through FIG. 38 illustrate side views of an example of a magnetics-based (magnetically-responsive) two-chamber reciprocal pump 800 that includes magnetically-responsive flexible membrane 400.

Magnetically-responsive two-chamber reciprocal pump 800 is another example of the presently disclosed microfluidic devices and methods including flexible membranes and/or magnetically-responsive elements.

Magnetically-responsive two-chamber reciprocal pump 800 may include, for example, a bottom substrate 805 with a top surface and a bottom surface, a first mask layer 812 with top surface and a bottom surface with two openings 814 (e.g., 814a, 814b) therethrough that are each sized to substantially align with a first pumping chamber and a second pumping chamber (e.g., 818a, 818b) in a second mask layer 816, and wherein the bottom surface of the first mask layer 812 is mounted on the top surface of the bottom substrate 805, a magnetically-responsive flexible membrane 400 with a top surface and a bottom surface, further comprising a first portion and a second portion of the magnetically-responsive flexible membrane 400 each held suspended in a free space having a span (s) (span (s) is not shown in the FIGS.) bounded by pumping chambers in the second mask layer 820 and the openings in the first mask layer 812, and wherein the bottom surface of the magnetically-responsive flexible membrane 400 is mounted on the top surface of the first mask layer 812.

Magnetically-responsive reciprocal pump 800 may include a second mask layer 816 with a top surface and a bottom surface comprising a first pumping chamber and a second pumping chamber 818 (e.g., 818a, 818b) that are sized to substantially align with the openings in the first mask layer and the free spaces of span (s) of the magnetically-responsive flexible membrane 400, wherein the first pumping chamber is bound by the first free space of span (s) of the magnetically-responsive flexible membrane 400 and a first portion of a bottom surface of a routing layer 820 having a span (s) and the second pumping chamber is bound by the second free space of span (s) of the magnetically-responsive flexible membrane 400 and a second portion of the bottom surface of the routing layer 820 having a span (s), wherein a third portion of the second mask layer is interspaced between the first pumping chamber and the second pumping chamber whereby a top surface of the third portion forms a bottom surface of a channel or reaction chamber 822, and wherein the bottom surface of the second mask layer is mounted on the top surface of the magnetically-responsive flexible membrane 400.

The magnetically-responsive reciprocal pump 800 may include a routing layer 820 with a top surface and a bottom surface with fluid inlet channels and fluid outlet channels (e.g., 826a, 826b) fluidly connecting to the pumping chambers in the second mask layer, wherein the first pumping chamber is bound by a first portion of the bottom surface of the routing layer 820 having a span (s) and the first portion of the top surface of the magnetically-responsive flexible membrane 400 and the second pumping chamber is bound by a second portion of the bottom surface of the routing layer 820 having a span (s) and the second portion of the top surface of the magnetically-responsive flexible membrane 400, wherein the pumping chambers are fluidly connecting to an open space comprising a channel or reaction chamber having a top surface and a bottom surface, and wherein the bottom surface of the routing layer 820 is mounted on the top surface of the second mask layer 816.

The magnetically-responsive reciprocal pump 800 may include a top substrate 824 with a top surface and a bottom surface comprising at least two fluid ports 826 (e.g., 826a, 826b) fluidly connecting to the pumping chambers, wherein a portion of the bottom surface of the top substrate 824 forms the top surface of the reaction chamber 822, and wherein the bottom surface of the top substrate 824 is mounted on the top surface of the routing layer 820. In one example, bottom substrate 805 may be a plastic or glass substrate that may be from about 1,000 μm to about 4,000 μm thick. Further, first mask layer 812, second mask layer 816, and top substrate 824 may be formed, for example, of plastic or glass and each may be from about 200 μm to about 800 μm thick.

Openings 814 (e.g., 814a, 814b) in first mask layer 812 substantially align with pumping chambers 818 (e.g., 818a, 818b) of second mask layer 816 such that a portion of magnetically-responsive flexible membrane 400 is held suspended in free space at each of two locations. Additionally, a flow channel (which includes the reaction chamber 822) is formed between the two fluid ports 826 (e.g., 826a, 826b). FIG. 35 shows a fluid 830 in an open flow channel between fluid ports 826a and 826b. Fluid 830 may be any fluid to be pumped through magnetically-responsive two-chamber reciprocal pump 800. FIG. 35 also shows magnetically-responsive flexible membrane 400 in a relaxed state in the absence of any magnetic force.

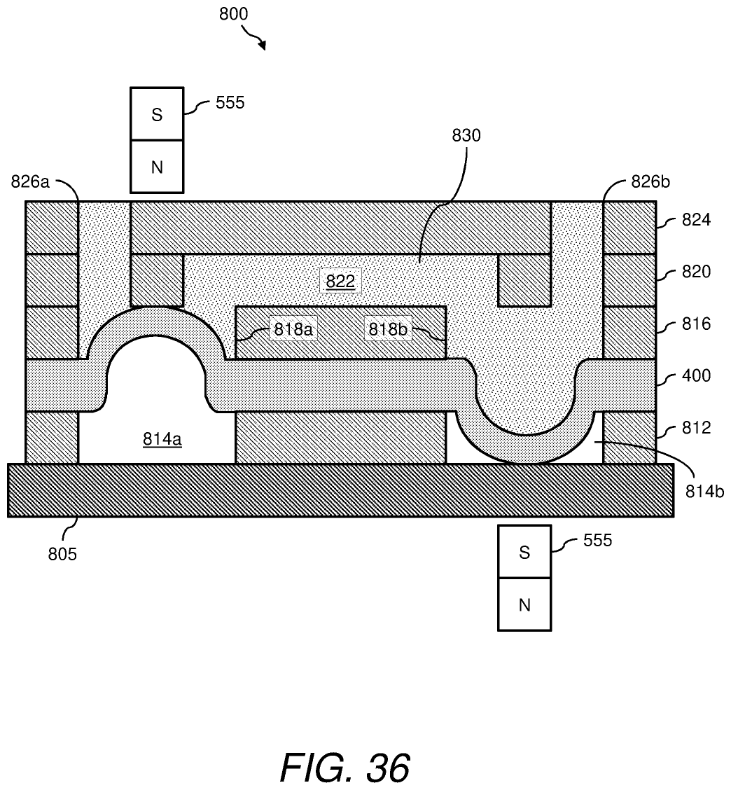

The operations of magnetically-responsive two-chamber reciprocal pump 800 are based on the steps of method 600 of FIG. 18. For example, in a first pumping cycle, FIG. 36 shows a first means for applying a magnetic force to the magnetically-responsive flexible membrane 400, e.g., a first top magnet 555, is provided in close proximity to top substrate 824 and positioned at or near pumping chamber 818a, and wherein the first means for providing a magnetic force is arranged relative to the first free space of span (s) such that application of the magnetic force to the first free space of span (s) causes the magnetically-responsive flexible membrane 400 to deflect upwards to contact the first portion with span (s) of the bottom surface of the routing layer 820, thereby forming a seal to prevent the flow of fluid from the fluid inlet port 826a into the first pumping chamber 818a. As such, at pumping chamber 818a, magnetically-responsive flexible membrane 400 deflects upward toward top substrate 824, which is toward first top magnet 555.

At the same time, a second means for providing a magnetic force to the magnetically-responsive flexible membrane 400, e.g., a first bottom magnet 555, is provided in close proximity to bottom substrate 805 and positioned at or near pumping chamber 818b, wherein the second means for providing a magnetic force is arranged relative to the second free space of span (s) such that application of the magnetic force to the second free space of span (s) causes the magnetically-responsive flexible membrane 400 to deflect downwards to contact the top surface of the bottom substrate 805, thereby allowing fluid to flow from the reaction chamber 822 to the fluid outlet port 826b via the second pumping chamber 818b. As such, at second pumping chamber 818b, magnetically-responsive flexible membrane 400 deflects downward toward bottom substrate 805, which is toward first bottom magnet 555.

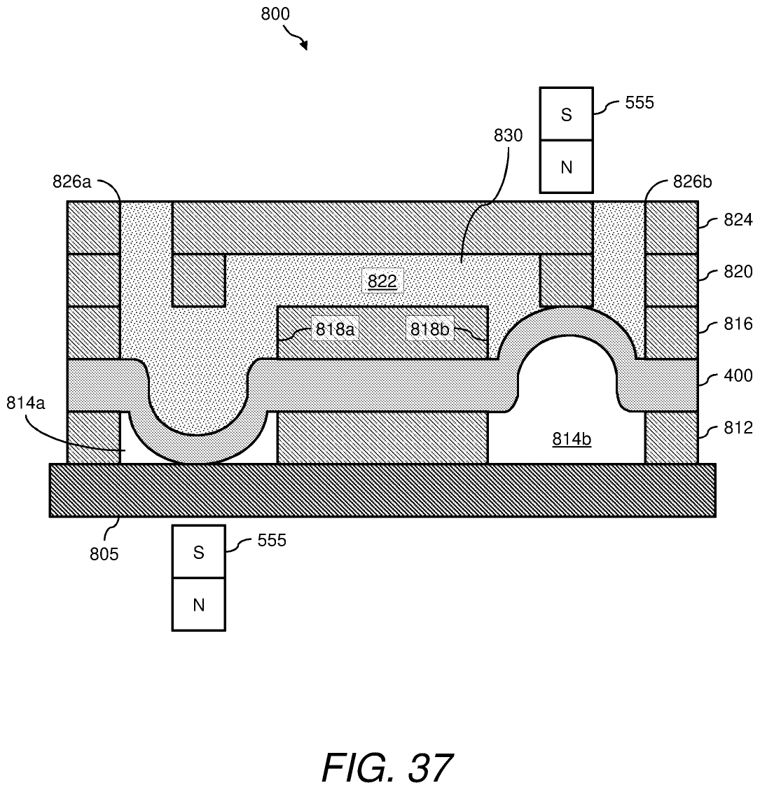

Next, in a second pumping cycle, FIG. 37 shows a third means for providing a magnetic force to the magnetically-responsive flexible membrane 400, e.g., a second top magnet 555, provided in close proximity to top substrate 824 and positioned at or near pumping chamber 818b, wherein the third means for providing a magnetic force is arranged relative to the first free space of span (s) such that application of the third magnetic force to the first free space of span (s) causes the magnetically-responsive flexible membrane 400 to deflect downwards to contact the top surface of the bottom substrate 805, thereby allowing fluid to flow from the fluid inlet port 826a into the reaction chamber 822 via the first pumping chamber 818a. As such, at pumping chamber 818a, magnetically-responsive flexible membrane 400 deflects downward toward bottom substrate 805, which is toward second bottom magnet 555.

At the same time, a fourth means for providing a magnetic force to the magnetically-responsive flexible membrane 400, e.g., a second top magnet 555, is provided in close proximity to top substrate 824 and positioned at or near pumping chamber 818b, wherein the fourth means for providing a magnetic force is arranged relative to the second free space of span (s) such that application of the fourth magnetic force to the second free space of span (s) causes the magnetically-flexible membrane 400 to deflect upwards to contact the second portion of span (s) of the bottom surface of the routing layer 820, thereby preventing the flow of fluid from the reaction chamber 822 into the second pumping chamber 818b. As a result, at pumping chamber 818b, magnetically-responsive flexible membrane 400 deflects upward toward top substrate 8820, which is toward second top magnet 555.

Accordingly, magnetically-responsive two-chamber reciprocal pump 800 operates by alternating a first cycle of top/bottom magnets 555 (first and second magnetic force means) and a second cycle of top/bottom magnets 555 (third and fourth magnetic force means) between pumping chambers 818a and 818b and in opposite fashion. The alternating deflection of magnetically-responsive flexible membrane 400 at pumping chambers 818a and 818b provides the reciprocal pumping action, i.e., causing a (continuous) reciprocating flow of fluid into and out of the reaction chamber 822; i.e., activating in sequence, first top magnet (first magnetic force means), first bottom magnet (second magnetic force means), second bottom magnet (third magnetic force means), and second top magnet (fourth magnetic force means). Top and bottom magnets 555 may be controlled at any selected magnetic force application frequency.

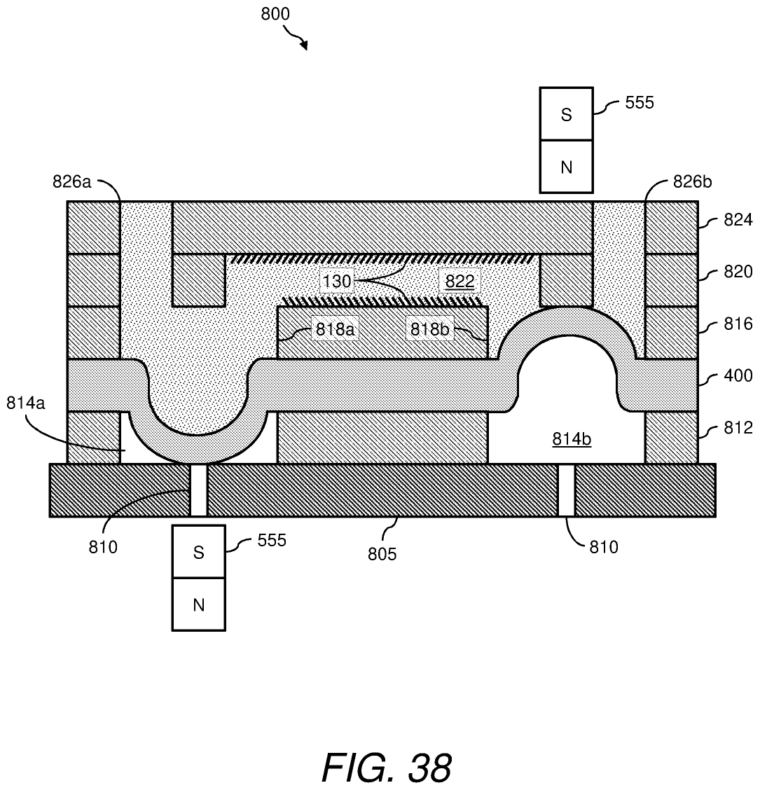

In another example, FIG. 38 shows magnetically responsive two-chamber reciprocal pump 800 may further include other features. For example, vents 810 may be provided at openings 814a and 814b for managing the air pressure thereof. Further, a field or array of magnetically-responsive surface-attached microposts 130 may be provided on any other surfaces of magnetically-responsive two-chamber reciprocal pump 800. The magnetically-responsive surface-attached microposts 130 may be actuated using, for example, the same top and bottom magnets 555 that are controlling magnetically-responsive flexible membrane 400.

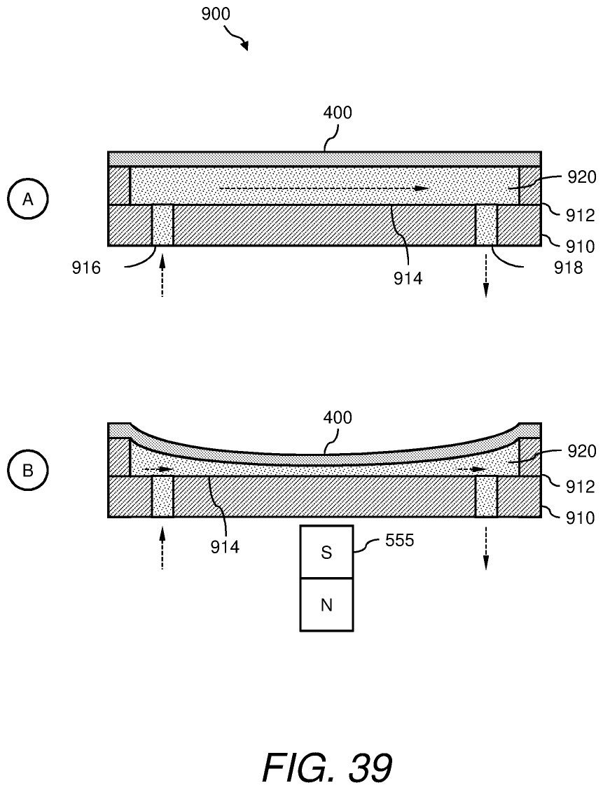

In another example, FIG. 39 shows an example of a magnetics-based (magnetically-responsive) flow metering device 900 and a process of using the same. Magnetically-responsive flow metering device 900 is another example of the presently disclosed microfluidic devices and methods including flexible membranes and/or magnetically responsive elements. Magnetically-responsive flow metering device 900 includes, for example, a bottom substrate 910 with a top surface and a bottom surface and a magnetically-responsive flexible membrane 400 with a top surface and a bottom surface separated by spacers 912 to form a flow chamber 914. That is, the bottom substrate 910 and the magnetically-responsive flexible membrane 400 are separated by spacers 912 having an inner surface and an outer surface, wherein the spacers 912 separate the top surface of the bottom substrate 910 and the bottom surface of the magnetically-responsive flexible membrane 400 thereby forming a flow chamber 914 bounded by the top surface of the bottom substrate 910, the bottom surface of the magnetically-responsive flexible membrane 400, and the inner surface of the spacers 912, and wherein the flow chamber 914 has an initial size and volume. An inlet 916 and an outlet 918 may be provided in bottom substrate 910.

Additionally, flow chamber 914 may be filled with a fluid 920. Further, fluid 920 may be flowing through flow chamber 914 from inlet 916 to outlet 918. A flexing means for flexing the magnetically-responsive flexible membrane 400, such as a pumping force means, e.g., an external pumping force such as an external pump (not shown) and/or a magnetic force means such as magnet 555, is provided, wherein the pumping force means for providing pumping force is arranged relative to the flow chamber 914 such that applying the pumping force causes fluid 920 to flow into the flow chamber 914. Using magnetically-responsive flow metering device 900, the fluid metering process may include, but is not limited to, the following steps.

In a step A, magnetically-responsive flexible membrane 400 is in the relaxed (non-deflected) state (see FIG. 2) in the absence of a flexing means for flexing the magnetically-responsive flexible membrane 400, which allows flow chamber 914 to be filled with fluid 920. This also allows fluid 920 to flow freely through flow chamber 914 from inlet 916 to outlet 918 via, for example, a means for applying a pumping force (not shown), e.g., an external pump.

In a step B, a flexing force means, such as a means for applying a magnetic force, e.g., a magnet 555, is placed in close proximity to bottom substrate 910, wherein the flexing force means for flexing the flexible membrane 400 is arranged relative to the flexible membrane such that applying the flexing force causes the flexible membrane 400 to deflect downward towards the bottom substrate 910 and not applying the flexing force causes the flexible membrane to return to a non-deflected state. This deflection restricts the flow of fluid 920 through flow chamber 914 from inlet 916 to outlet 918. In this way, the volume of fluid 920 flowing through flow chamber 914 may be metered (measured) or controlled by the amount of deflection of flexible membrane 400. That is, the flexing means is arranged relative to the flexible membrane 400 such that flexing the flexible membrane 400 causes the flow chamber 914 to decrease in size and volume compared to its initial size and volume or to increase in size and volume compared to its initial size and volume. The amount of deflection of flexible membrane 400 may be controlled, e.g., by controlling the magnetic field strength of the means for applying (or not applying, as the case may be) a magnetic force, e.g., via a magnet 555, to a magnetically-responsive flexible membrane according to the invention.

In FIG. 1 through FIG. 39, the microfluidic devices and methods including flexible membranes and/or magnetically-responsive elements (e.g., flow/mixer device 100, flow/mixer device 200, integrated structure 300, magnetics-based pinch valve 500, magnetic-based single-chamber mixer 700, magnetic-based two-chamber reciprocal pump 800, magnetic-based flow metering device 900) may be mass produced using any large-scale manufacturing process, such as a wafer-level manufacturing process. In one example, flow/mixer device 100, flow/mixer device 200, integrated structure 300, magnetic-based pinch valve 500, magnetic-based single-chamber mixer 700, magnetic-based two-chamber reciprocal pump 800, and/or magnetic-based flow metering device 900 may be formed according to the processes described with reference to U.S. Patent App. No. 62/522,536, entitled “Modular Active Surface Devices for Microfluidic Systems and Methods of Making Same.”

Referring now again to FIG. 1 through FIG. 39, with respect to any of the presently disclosed microfluidic devices and methods including flexible membranes and/or magnetically responsive elements (e.g., flow/mixer device 100, flow/mixer device 200, integrated structure 300, magnetic-based pinch valve 500, magnetic-based single-chamber mixer 700, magnetic-based two-chamber reciprocal pump 800, magnetic-based flow metering device 900), the terms “top,” “bottom,” “upper,” “lower,” “over,” “under,” “in,” and “on” are used throughout the description with reference to the relative positions of the components thereof. It will be appreciated that the microfluidic devices are functional regardless of their orientation in space.

Although the foregoing subject matter has been described in some detail by way of illustration and example for purposes of clarity of understanding, it will be understood by those skilled in the art that certain changes and modifications can be practiced within the scope of the appended claims.

We claim:

1. A magnetically actuated pump comprising;
(a) one or more substrates and a first flexible membrane arranged to form a pumping chamber having an initial size and volume;
(b) one or more ports into the pumping chamber.

2. The magnetically actuated pump of any of claims 1 and following, wherein:
(a) the one or more substrates comprises:
(i) a base substrate having a top surface and a bottom surface;
(ii) one or more spacers, each having one or more inner surfaces and an outer surfaces;
(b) the first flexible membrane has a top surface and a bottom surface, and
(c) the one or more spacers separate the top surface of the substrate and the bottom surface of the flexible membrane thereby forming a flow chamber bounded by:
(i) the top surface of the base substrate,
(ii) the bottom surface of the flexible membrane, and
(iii) the one or more inner surfaces of the one or more spacers, and
(d) the one or more ports comprise:
(i) one or more ports in the substrate;
(ii) one or more ports in any of the one or more spacers; and/or
(iii) one or more ports in the membrane.

3. The magnetically actuated pump of any of claims 1 and following, wherein the one or more substrates comprise a rigid substrate.

4. The magnetically actuated pump of any of claims 1 and following, wherein the one or more substrates comprise a flexible substrate.

5. The magnetically actuated pump of any of claims 1 and following, wherein the one or more substrates comprise a second flexible membrane.

6. The magnetically actuated pump of any of claims 1 and following, wherein the bottom surface of the flexible membrane comprises actuatable microposts extending into the flow chamber.

7. The magnetically actuated pump of any of claims 1 and following, wherein the top surface of the substrate comprises actuatable microposts extending into the flow chamber.

8. The magnetically actuated pump of any of claims 1 and following, wherein flexible membrane is configured so that flexing the flexible membrane towards the substrate causes the flow chamber to have a decreased size and volume compared to the initial size and volume.

9. The magnetically actuated pump of any of claims 1 and following, wherein the flexible membrane is configured so that flexing the flexible membrane away from the substrate causes the flow chamber to have an increased size and volume compared to its initial size and volume.

10. The magnetically actuated pump of any of claims 1 and following, wherein the one or more substrates comprise a substrate formed of a flexible and magnetically responsive material.

11. The magnetically actuated pump of any of claims 1 and following, wherein the flexible membrane is formed of a flexible and magnetically responsive material.

12. The magnetically actuated pump of any of claims 1 and following, wherein the flexible membrane has a thickness ranging from about 500 μM to about 3,000 μM.

13. The magnetically actuated pump of any of claims 1 and following, wherein the flexible membrane has a thickness ranging from about 200 μM to about 1,500 μM.

14. The magnetically actuated pump of claim 10 or 11, wherein the flexible and magnetically responsive material comprises silicone, hydrogel, polydimethylsiloxane (PDMS), a thermoplastic elastomer, and/or a fluoropolymer.

15. The magnetically actuated pump of claim 10 or 11, wherein the flexible and magnetically responsive material comprises iron, nickel, cobalt, ferroferric oxide, barium hexaferrite, cobalt(II) oxide, nickel(II) oxide, manganese(III) oxide, chromium(III) oxide, and/or cobalt manganese phosphide.

16. The magnetically actuated pump of any of claims 1 and following, wherein the ports comprise one or more ports in the substrate.

17. The magnetically actuated pump of any of claims 1 and following, wherein the ports comprise one or more ports in the one or more spacers.

18. The magnetically actuated pump of any of claims 1 and following, wherein the ports comprise one or more ports in the flexible membrane.

19. The magnetically actuated pump of any of claims 1 and following, wherein the one or more ports are valved.

20. The magnetically actuated pump of any of claims 1 and following, wherein the one or more ports are coupled to microfluidic passages of a microfluidic device.

21. The magnetically actuated pump of any of claims 1 and following, wherein the one or more ports are coupled to valved microfluidic passages of a microfluidic device.

22. The magnetically actuated pump of any of claims 1 and following, wherein substrate comprises a bowl-shaped region.

23. The magnetically actuated pump of any of claims 1 and following, wherein substrate comprises a dome shaped region.

24. A microfluidics system comprising:
(a) the magnetically actuated pump of any of the foregoing claims; and
(b) a magnet actuator arranged to actuate the flexible membrane and thereby cause fluid to flow into and/or out of the chamber.

25. A microfluidics system comprising:
(a) the magnetically actuated pump of any of the foregoing claims; and
(b) a magnet actuator arranged to magnetically effect peristaltic actuation of the flexible membrane and thereby cause fluid to flow into and/or out of the chamber.

26. A microfluidics system comprising:
(a) two magnetically actuated pump of any of the foregoing claims arranged for reciprocal pumping of liquid in the chamber; and
(b) one or more a magnet actuators arranged to magnetically effect reciprocal actuation of the flexible membrane and thereby cause fluid to flow into and/or out of the chamber.

27. A method of pumping liquid comprising:
(a) providing the microfluidics system of any of claims 24-26;
(b) causing the magnet actuator arranged to actuate the flexible membrane and thereby cause fluid to flow into and/or out of the chamber.

28. A method of pumping liquid comprising:
(a) providing the microfluidics system of any of claims 24-26;
(b) causing the magnet actuator arranged to actuate the flexible membrane and thereby cause fluid to flow into the chamber via a first port and out of the chamber via a second port.

29. A method of pumping liquid comprising:
(a) providing the microfluidics system of any of claims 24-26;
(b) causing the magnet actuator arranged to actuate the flexible membrane and thereby cause fluid to flow into the chamber via a first valve-controlled port and out of the chamber via a valve controlled second port.

30. A method of pumping liquid comprising:
(a) pumping the liquid pursuant to any of claims 27-29; and
(b) actuating the actuatable microposts to cause mixing of fluid in the chamber.

31. The method of any of claims 27 and following, comprising repeatedly flexing the flexible membrane to cause fluid to flow into and out of the chamber via the one or more ports.

32. The method of any of claims 27 and following, wherein the flexing means is selected from the group consisting of a solenoid and piston mechanism and a pneumatic mechanism.

33. The method of any of claims 27 and following, wherein the flexible membrane comprises actuatable microposts extending into the flow chamber, and the method comprises applying an actuating force to actuate the microposts to thereby mix fluid in the chamber.

34. The method of any of claims 27 and following, wherein the fluid comprises a sample, a reagent, or a combination thereof.

35. A magnetically actuated flow metering device comprising one or more substrates and a first flexible membrane arranged to form an open or closed fluid flow path.

36. A magnetically actuated flow metering device of any of claims 35 and following, wherein the one or more substrates comprise a rigid substrate.

37. The magnetically flow metering device of any of claims 35 and following, wherein the one or more substrates comprise a flexible substrate.

38. The magnetically flow metering device of any of claims 35 and following, wherein the one or more substrates comprise a second flexible membrane.

39. The magnetically flow metering device of any of claims 35 and following, wherein flexible membrane is configured so that flexing the flexible membrane towards the flow path reduces flow through the flow path.

40. The magnetically flow metering device of any of claims 35 and following, wherein flexible membrane is configured so that flexing the flexible membrane away from the flow path reduces flow through the flow path.

41. The magnetically flow metering device of any of claims 35 and following, wherein flexible membrane is configured so that flexing the flexible membrane towards the flow path closes the flow path.

42. The magnetically flow metering device of any of claims 35 and following, wherein flexible membrane is configured so that flexing the flexible membrane away from the flow path closes the flow path.

43. The magnetically flow metering device of any of claims 35 and following, wherein flexible membrane is biased to closed.

44. The magnetically flow metering device of any of claims 35 and following, wherein flexible membrane is biased to open.

45. The magnetically flow metering device of any of claims 35 and following, wherein flexible membrane has a thickness ranging from about 500 μM to about 3,000 μM.

46. The magnetically flow metering device of any of claims 35 and following, wherein flexible membrane has a thickness ranging from about 200 μM to about 1,500 μM.

47. The magnetically flow metering device of any of claims 35 and following, wherein flexible membrane is formed of a flexible and magnetically responsive material.

48. The magnetically flow metering device of claim 47, wherein the flexible and magnetically responsive material comprises silicone, hydrogel, polydimethylsiloxane (PDMS), a thermoplastic elastomer, and/or a fluoropolymer.

49. The magnetically flow metering device of claim 47, wherein the flexible and magnetically responsive material comprises iron, nickel, cobalt, ferroferric oxide, barium hexaferrite, cobalt(II) oxide, nickel(II) oxide, manganese(III) oxide, chromium(III) oxide, and/or cobalt manganese phosphide.

50. The magnetically flow metering device of any of claims 35 and following, wherein the one or more ports are coupled to microfluidic passages of a microfluidic device.

51. The magnetically flow metering device of any of claims 35 and following, wherein the one or more ports are coupled to valved microfluidic passages of a microfluidic device.

52. The magnetically flow metering device of any of claims 35 and following, wherein substrate comprises a bowl-shaped region.

53. The magnetically flow metering device of any of claims 35 and following, wherein substrate comprises a dome shaped region.
